(19) United States
(12) Patent Application Publication
(10) Pub. No.: US 2026/0312057 A1
(43) Pub. Date: Oct. 8, 2026

(54) HYDROXYL-MODIFIED BINDER AND PREPARATION METHOD THEREOF, AND SECONDARY BATTERY

(71) Applicant: Ningde Amperex Technology Limited, Ningde (CN)

(72) Inventor: Xinlai ZHENG, Ningde (CN)

(73) Assignee: Ningde Amperex Technology Limited, Ningde (CN)

(21) Appl. No.: 19/575,998

(22) Filed: Mar. 24, 2026

(30) Foreign Application Priority Data
Apr. 3, 2025 (CN) 202510418063.7

(51) Int. Cl. H01M 4/62; C08F 220/06; C08F 220/28; C08F 220/58; C08F 222/26; H01M 4/02; H01M 4/133; H01M 4/587

(52) U.S. Cl. CPC H01M 4/622; C08F 220/06; C08F 220/281; C08F 220/58; C08F 222/26; H01M 4/133; H01M 4/587; C08F 2800/20; H01M 2004/027

(57) ABSTRACT

A hydroxyl-modified binder includes a copolymer. Monomers forming the copolymer include a first monomer and a second monomer. The first monomer includes at least one of acrylic acid, acrylamide, or acrylonitrile. The second monomer includes a compound of Formula I. The first monomer and the second monomer constitute a first monomer unit and a second monomer unit of the copolymer respectively. Based on a mass of the copolymer, a mass percentage of the first monomer unit is A %, and a mass percentage of the second monomer unit is B %, wherein 5≤A≤60 and 40≤B≤95.

### CROSS-REFERENCE TO RELATED APPLICATION

This application claims priority to Chinese Patent Application No. 202510418063.7, filed on Apr. 3, 2025, the whole disclosure of which is incorporated herein by reference.

### TECHNICAL FIELD

This application relates to the field of electrochemical technology, and in particular, to a hydroxyl-modified binder and a preparation method thereof, and a secondary battery.

### BACKGROUND

Secondary batteries, such as a lithium-ion battery, have been widely used in various small devices such as mobile phones, digital cameras, laptops, and unmanned aerial vehicles due to advantages such as a high energy density, a high operating voltage, and environmental friendliness, and currently occupy a dominant position in the field of power supplies for portable electronic devices.

High-capacity silicon negative electrodes are the most promising next-generation negative electrode material to partially replace commercial graphite for use in lithium-ion batteries. However, this material induces enormous volume expansion during lithium intercalation, and leads to problems such as fracture of a solid electrolyte interface and pulverization of electrodes, thereby causing rapid capacity fading. The large volume expansion of the silicon negative electrode limits the development thereof. A self-healing binder can regenerate its original structure and can cope with the continuous expansion and contraction of a silicon negative electrode system during cycling, thereby effectively alleviating cycling expansion. For example, polyvinyl alcohol (PVA)-type binders and the binders containing a large number of hydroxyl groups (which contain abundant hydrogen bonds due to the high hydroxyl content) exhibit excellent self-healing properties However, a problem with PVA-type binders is that their hydroxyl groups are highly reactive and consequently tend to generate gas during cycling of the secondary battery and during low-voltage storage, thereby causing swelling of the secondary battery and posing a relatively high risk of failure in the market.

### SUMMARY

An objective of this application is to provide a hydroxyl-modified binder and a preparation method thereof, and a secondary battery, so as to achieve superior cycling expansion performance and low-voltage storage safety performance of the secondary battery concurrently. Specific technical solutions are as follows:

A first aspect of this application provides a hydroxyl-modified binder. The hydroxyl-modified binder is a copolymer. Monomers forming the copolymer include a first monomer and a second monomer. The first monomer includes at least one of acrylic acid, acrylamide, or acrylonitrile, and the second monomer includes a compound of Formula I:

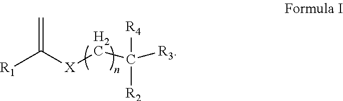

In the formula, X is selected from C, an ester bond, an ether bond, a methyleneoxy group, or an amide bond; R₁ is selected from H or methyl. R₂, R₃, and R₄ each are independently selected from H, methyl, hydroxyl, or hydroxymethyl. At least one of R₂, R₃, or R₄ is selected from hydroxyl or hydroxymethyl, and n is 0, 1, or 2. The first monomer and the second monomer constitute a first monomer unit and a second monomer unit of the copolymer respectively. Based on a mass of the copolymer, a mass percentage of the first monomer unit is A %, satisfying: 5≤A≤60, and a mass percentage of the second monomer unit is B %, satisfying: 40≤B≤95. The hydroxyl-modified binder contains a hydrogen bond structure and exhibits excellent self-healing properties, and can regenerate its original structure. Applying the hydroxyl-modified binder to a negative electrode plate of a secondary battery not only alleviates continuous expansion and contraction of the silicon negative electrode system during cycling, but also alleviates the problem of swelling during cycling and low-voltage storage of the secondary battery, thereby improving both the cycling expansion performance and low-voltage storage safety performance of the secondary battery.

In some embodiments of this application, the second monomer includes at least one of β-hydroxypropyl acrylate, hydroxypropyl methacrylate, hydroxyethyl acrylate, hydroxyethyl methacrylate, 3-hydroxypropyl acrylate, 4-hydroxybutyl acrylate, 4-penten-1-ol, pentaerythritol allyl ether, or N-(2-hydroxyethyl)acrylamide. The second monomer falling within the above range provides a hydroxyl group of appropriate reactivity for the hydroxyl-modified binder, and enables the hydroxyl-modified binder to possess excellent self-healing properties. This not only alleviates the continuous expansion and contraction of the silicon negative electrode system during cycling, but also alleviates the swelling of the secondary battery during cycling and low-voltage storage, thereby improving the cycling expansion performance and low-voltage storage safety performance of the secondary battery.

In some embodiments of this application, 5≤A≤40, and 60≤B≤95. Controlling the values of A and B to fall within the above ranges further improves the cycling expansion performance and low-voltage storage safety performance of the secondary battery.

In some embodiments of this application, when the hydroxyl-modified binder is dispersed in water at a temperature of 25° C. and stirred at a speed of 12 rpm for 2 minutes to form an aqueous dispersion in which a mass percentage of the hydroxyl-modified binder is 5.5% to 6.5%, a viscosity of the aqueous dispersion of the hydroxyl-modified binder ranges from 3000 mPa·s to 100000 mPa·s. Controlling the viscosity of the aqueous dispersion of the hydroxyl-modified binder to fall within the above range facilitates sufficient spreading of a molecular chain and bonding of the molecular chain to the negative active material particles, thereby improving the cycling expansion performance and low-voltage storage safety performance of the secondary battery.

In some embodiments of this application, an infrared spectrum of the hydroxyl-modified binder exhibits a stretching vibration peak of hydroxyl groups at 3000 cm⁻¹ to 3600 cm⁻¹. A peak intensity of the stretching vibration peak at 100° C. is I₁, and a peak intensity of the stretching vibration peak at 30° C. is I₂, satisfying: I_{OH}=I₁/I₂, and I_{OH}≥1.1. The I_{OH} value falling within the above range indicates that the hydroxyl content in the hydroxyl-modified binder changes with temperature, and demonstrates that the modified binder possesses excellent self-healing properties, thereby improving the cycling expansion performance and low-voltage storage safety of the secondary battery.

In some embodiments of this application, 1.15≤I_{OH}≤2. The value of I_{OH} falling within the above range further improves the cycling expansion performance and low-voltage storage safety performance of the secondary battery.

In some embodiments of this application, as tested by means of cyclic voltammetry, during a charge-discharge cycle of the hydroxyl-modified binder cycled at a voltage of 0 V to 3.3 V, a weakest current signal value of hydrogen is Q₁ A, and a strongest current signal value of hydrogen is Q₂ A, satisfying: Qᵥ=Q₁/Q₂, and 0.8≤Qᵥ≤0.9. The Qᵥ value falling within the above range indicates that the amount of gas generated by the secondary battery during cycling and low-voltage storage is small, and demonstrates excellent cycling expansion performance and low-voltage storage safety performance.

In some embodiments of this application, the hydroxyl-modified binder satisfies at least one of the following characteristics: (1) a Young's modulus of a film of the hydroxyl-modified binder is 1.2 GPa to 7 GPa; or (2) an elongation-at-break of the film of the hydroxyl-modified binder is 12% to 85%. The fact that the hydroxyl-modified binder satisfies at least one of the above characteristics indicates that the hydroxyl-modified binder is of high toughness. Applying the binder to a negative electrode plate can alleviate the problem of interfacial pulverization during cycling of the negative electrode plate, thereby improving the cycling expansion performance of the secondary battery.

A second aspect of this application provides a method for preparing the hydroxyl-modified binder provided in the first aspect of this application. The method includes the following steps:
(1) dissolving the second monomer in a solvent and stirring under protection of an inert atmosphere to obtain a deoxygenated solution;
(2) adding a free-radical initiator into the deoxygenated solution, and then adding the first monomer under protection of an inert atmosphere to perform a copolymerization reaction to obtain a mixed solution containing the hydroxyl-modified binder; and
(3) stirring the mixed solution under negative pressure to remove monomers and isolate the hydroxyl-modified binder.

The solvent includes at least one of deionized water, ethanol, or acetone; a mass ratio of the second monomer to the solvent is 1:(1000 to 5000); a mass ratio of the second monomer to the free-radical initiator is 1:(0.1 to 2); based on a total mass of the first monomer and the second monomer, a mass percentage of the first monomer is 5% to 60%, and a mass percentage of the second monomer is 40% to 90%. The copolymerization reaction is performed at a temperature of 50° C. to 80° C. for a duration of 2 h to 8 h, the negative pressure is set to −0.1 MPa to −0.07 MPa, and the removal of the monomers is performed for a duration of 1 h to 5 h.

The hydroxyl-modified binder prepared using the above preparation method possesses excellent self-healing properties, and can regenerate its original structure. Applying the hydroxyl-modified binder to a negative electrode plate of a secondary battery not only alleviates continuous expansion and contraction of the silicon negative electrode system during cycling, but also alleviates the problem of swelling during cycling and low-voltage storage of the secondary battery, thereby improving the cycling expansion performance and low-voltage storage safety performance of the secondary battery.

A third aspect of this application provides a secondary battery. The secondary battery includes a negative electrode plate. The negative electrode plate includes a negative current collector and a negative electrode material layer disposed on at least one surface of the negative current collector. The negative electrode material layer includes a negative active material. The negative active material includes a silicon-containing material. The negative electrode material layer further includes the hydroxyl-modified binder provided in the first aspect hereof or a hydroxyl-modified binder prepared using the preparation method provided in the second aspect hereof That the negative electrode material layer includes the above hydroxyl-modified binder not only alleviates continuous expansion and contraction of the silicon negative electrode system during cycling, but also alleviates the problem of swelling during cycling and low-voltage storage of the secondary battery, thereby improving both the cycling expansion performance and low-voltage storage safety performance of the secondary battery.

In some embodiments of this application, the silicon-containing material includes at least one of silicon, a silicon-carbon compound, or a silicon-oxygen compound. Based on a mass of the negative electrode material layer, a mass percentage of silicon is M %, satisfying: 0.5≤M≤60. Selecting the silicon-containing material within the above range and controlling the mass percent of silicon to fall within the above range endow the secondary battery with a relatively high energy density, and make it more convenient to exert the self-healing effect of the hydroxyl-modified binder in the silicon negative electrode system, thereby improving the cycling expansion performance and low-voltage storage safety performance of the secondary battery.

In some embodiments of this application, 5≤M≤40. Controlling the value of M to fall within the above range further improves the cycling expansion performance and low-voltage storage safety performance of the secondary battery.

In some embodiments of this application, based on a mass of the negative electrode material layer, a mass percentage of the hydroxyl-modified binder is N %, satisfying: 1.2≤N≤11.5. By controlling the mass percent of the hydroxyl-modified binder to fall within the above range, this application achieves strong adhesion between particles of the negative active material, exerts the self-healing effect of the hydroxyl-modified binder in the silicon negative electrode system, endows the negative electrode material layer with a relatively high gravimetric capacity, thereby endowing the secondary battery with a relatively high energy density and excellent cycling expansion performance and low-voltage storage safety performance.

In some embodiments of this application, 1.2≤N≤8. Controlling the value of N to fall within the above range further improves the cycling expansion performance and low-voltage storage safety performance of the secondary battery.

In some embodiments of this application, based on the mass of the negative electrode material layer, the mass percent of the hydroxyl-modified binder is N %, satisfying: 0.12≤N/M≤3.2. With the N/M ratio value controlled within the above range, the synergistic effect between the hydroxyl-modified binder and the silicon in the negative electrode material layer is strong, the self-healing function of the hydroxyl-modified binder in the silicon negative electrode system is exerted more efficiently, so that the secondary battery achieves a relatively high energy density and higher levels of cycling expansion performance and low-voltage storage safety performance.

In some embodiments of this application, 0.24≤N/M≤1.6. Controlling the value of N/M to fall within the above range further improves the cycling expansion performance and low-voltage storage safety performance of the secondary battery.

Some of the beneficial effects of this application are as follows:

This application provides a hydroxyl-modified binder and a preparation method thereof, and a secondary battery. The hydroxyl-modified binder is a copolymer. Monomers forming the copolymer include a first monomer and a second monomer. The first monomer includes at least one of acrylic acid, acrylamide, or acrylonitrile. The second monomer includes a compound of Formula I. The first monomer and the second monomer constitute a first monomer unit and a second monomer unit of the copolymer respectively. Based on a mass of the copolymer, a mass percentage of the first monomer unit is A %, satisfying: 5≤A≤60, and a mass percentage of the second monomer unit is B %, satisfying: 40≤B≤95. The hydroxyl-modified binder contains a hydrogen bond structure and exhibits excellent self-healing properties, and can regenerate its original structure. Applying the hydroxyl-modified binder to a negative electrode plate of a secondary battery not only alleviates continuous expansion and contraction of the silicon negative electrode system during cycling, but also alleviates the problem of swelling during cycling and low-voltage storage of the secondary battery, thereby improving the cycling expansion performance and low-voltage storage safety performance of the secondary battery.

Definitely, a single product or method in which the technical solution of this application is implemented does not necessarily achieve all of the above advantages concurrently.

### BRIEF DESCRIPTION OF DRAWINGS

To describe the technical solutions in some embodiments of this application more clearly, the following outlines the drawings to be used in the description of the embodiments. Evidently, the drawings outlined below merely illustrate some embodiments of this application, and a person of ordinary skill in the art may derive other embodiments based on the drawings.

FIG. 1 shows infrared spectra of a hydroxyl-modified binder at 30° C. and 100° C. according to Embodiment 1-1;

FIG. 2 shows infrared spectra of a binder at 30° C. and 100° C. according to Comparative Embodiment 2;

FIG. 3 shows a differential electrochemical mass spectrometry spectrum of a hydroxyl-modified binder tested by means of cyclic voltammetry according to Embodiment 1-2; and

FIG. 4 shows a differential electrochemical mass spectrometry spectrum of a binder tested by means of cyclic voltammetry according to Comparative Embodiment 2.

### DETAILED DESCRIPTION

The following describes the technical solutions in this application clearly and comprehensively with reference to the embodiments and accompanying drawings hereof. Evidently, the described embodiments are merely a part of but not all of the embodiments of this application. All other embodiments derived by a person skilled in the art based on this application still fall within the protection scope of this application.

It is noted that in specific embodiments of this application, this application is construed by using a lithium-ion battery as an example of the secondary battery, but the secondary battery of this application is not limited to the lithium-ion battery.

A first aspect of this application provides a hydroxyl-modified binder. The hydroxyl-modified binder is a copolymer. Monomers forming the copolymer include a first monomer and a second monomer. The first monomer includes at least one of acrylic acid, acrylamide, or acrylonitrile, and the second monomer includes a compound of Formula I:

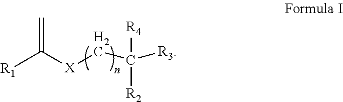

In the formula, X is selected from C, an ester bond

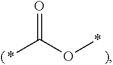 [SMILES: *OC(*)=O]

an ether bond (*—O—*) a methyleneoxy group

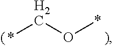 [SMILES: *CO*]

or an amide bond

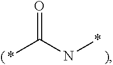 [SMILES: *NC(*)=O]

R₁ is selected from H or methyl; R₂, R₃, and R₄ each are independently selected from H, methyl, hydroxyl, or hydroxymethyl. At least one of R₂, R₃, or R₄ is selected from hydroxyl or hydroxymethyl; and n is 0, 1, or 2. The first monomer and the second monomer constitute a first monomer unit and a second monomer unit of the copolymer respectively. Based on a mass of the copolymer, a mass percentage of the first monomer unit is A %, satisfying: 5≤A≤60, and preferably 5≤A≤40. A mass percentage of the second monomer unit is B %, satisfying: 40≤B≤95, and preferably 60≤B≤95. For example, the value of A may be 5, 10, 14.2, 17, 20, 23, 26, 30, 33, 35, 37, 40, 48, 50, 55, 60, or a value falling within a range formed by any two thereof, and the value of B may be 40, 48, 50, 55, 60, 62, 69, 70, 75, 80, 85, 90, 95, or a value falling within a range formed by any two thereof.

The applicant hereof finds that when the n in the molecular structure (Formula I) of the second monomer is excessively large, for example, when the second monomer is 5-hydroxypentyl acrylate

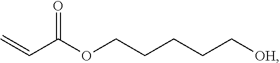

n=3, the excessive methylene groups in the molecular main chain of the second monomer dilutes the hydroxyl groups in the molecular chain of the copolymer, thereby precluding the hydroxyl-modified binder from exerting a self-healing effect. The silicon negative electrode system continuously expands during cycling, thereby adversely affecting the cycling expansion performance of the secondary battery. When the molecular main chain of the second monomer is too short to satisfy Formula I, for example, when the second monomer is 2-(hydroxymethyl) methacrylate

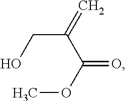

the hydroxyl concentration in the molecular chain of the copolymer is made excessively high. Consequently, the hydroxyl-modified binder agglomerates on the surface of particles of the negative active material, and is unable to be discretely distributed, thereby weakening the adhesion strength of the binder to the surface of particles of the negative active material. Further, the excessively high hydroxyl concentration in the molecular chain of the copolymer exacerbates swelling of the secondary battery during cycling and low-voltage storage, thereby hindering improvement of the low-voltage storage safety performance of the secondary battery. Therefore, by selecting the first monomer and the second monomer falling within the above range to polymerize and form a copolymer, this application imparts hydrophilicity to the first monomer unit in the polymer, and improves the dispersibility of the hydroxyl-modified binder particles in the binder slurry, thereby facilitating discrete distribution and film formation of the hydroxyl-modified binder on the surface of particles of the negative active material. The second monomer unit provides hydroxyl groups, thereby imparting a hydrogen bond structure and self-healing properties to the hydroxyl-modified binder, and enabling regeneration of the original structure of the binder. Applying the hydroxyl-modified binder to a negative electrode plate of a secondary battery not only alleviates continuous expansion and contraction of the silicon negative electrode system during cycling, but also alleviates the problem of swelling during cycling and low-voltage storage of the secondary battery, thereby achieving superior cycling expansion performance and low-voltage storage safety performance of the secondary battery concurrently. In addition, the first monomer unit can impart dispersibility to the copolymer, and the second monomer unit can impart a self-healing function to the copolymer. When the value of A is excessively small, for example, less than 5, the functional groups that provide dispersibility in the copolymer are fewer, thereby hindering improvement of the uniformity of the negative electrode material in the negative electrode plate. When the value of A is excessively large, for example, greater than 60, the copolymer is rigid but brittle and lacks toughness, resulting in an insufficient lifespan of the binder. The binder is prone to pulverize during cycling expansion, and the bonding interface is prone to crumble. When the value of B is excessively small, for example, less than 40, the hydroxyl content in the copolymer is excessively low, thereby hindering exertion of the self-healing effect of the hydroxyl-modified binder, and consequently hindering improvement of the cycling expansion performance of the secondary battery. When the value of B is excessively large, for example, greater than 95, the hydroxyl content in the copolymer is excessively high, making the secondary battery prone to generate gas during cycling or low-voltage storage. This exacerbates swelling of the secondary battery during cycling and low-voltage storage, and adversely affects the cycling expansion performance and low-voltage storage safety performance of the secondary battery. Therefore, controlling the values of A and B to fall within the ranges specified herein improves the cycling expansion performance and low-voltage storage safety performance of the secondary battery.

In some embodiments of this application, the second monomer includes at least one of β-hydroxypropyl acrylate (β-HPA), hydroxypropyl methacrylate, hydroxyethyl acrylate (HEA), hydroxyethyl methacrylate (2HEMA), 3-hydroxypropyl acrylate, 4-hydroxybutyl acrylate, 4-penten-1-ol, pentaerythritol allyl ether, or N-(2-hydroxyethyl)acrylamide (HEAA). The structural formulas of the above substances are shown below:

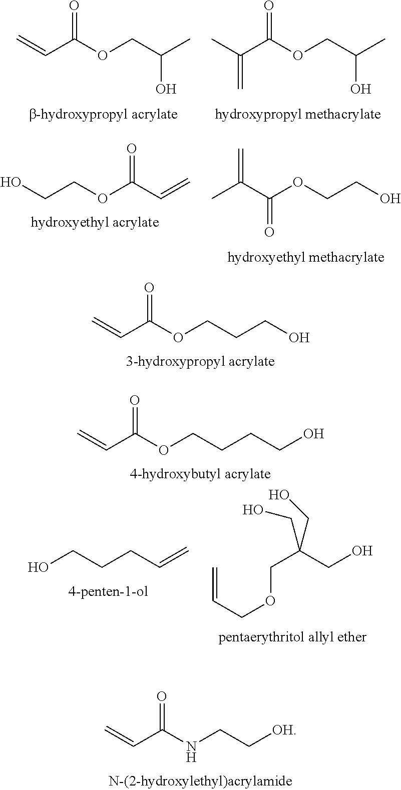

The second monomer falling within the above range contains polymerizable carbon-carbon double bonds and hydroxyl groups, and are of low chemical reactivity and high oxidation resistance. The second monomer falling within the above range provides a hydroxyl group of appropriate reactivity for the hydroxyl-modified binder, and enables the hydroxyl-modified binder to possess excellent self-healing properties. This not only alleviates the continuous expansion and contraction of the silicon negative electrode system during cycling, but also alleviates the swelling of the secondary battery during cycling and low-voltage storage, thereby improving the cycling expansion performance and low-voltage storage safety performance of the secondary battery.

In some embodiments of this application, when the hydroxyl-modified binder is dispersed in water at a temperature of 25° C. and stirred at a speed of 12 rpm for 2 minutes to form an aqueous dispersion in which the mass percent of the hydroxyl-modified binder is 5.5% to 6.5%, the viscosity of the aqueous dispersion of the hydroxyl-modified binder ranges from 3000 mPa·s to 100000 mPa·s. For example, the viscosity of the aqueous dispersion of the hydroxyl-modified binder may be 3000 mPa·s, 5000 mPa·s, 8000 mPa·s, 10000 mPa·s, 50000 mPa s, 75000 mPa·s, 100000 mPa·s, or a value falling within a range formed by any two thereof. By controlling the viscosity of the aqueous dispersion of the hydroxyl-modified binder to fall within the above range, this application enables the particles of the hydroxyl-modified binder to be highly dispersive in the slurry of the binder. When the hydroxyl-modified binder satisfying the above characteristics is applied to a silicon-containing negative electrode material layer, the hydroxyl-modified binder is highly dispersive on the surface of the particles of the negative active material, and is more capable of exerting a self-healing effect, thereby improving the cycling expansion performance and low-voltage storage safety performance of the secondary battery.

In some embodiments of this application, an infrared spectrum of the hydroxyl-modified binder exhibits a stretching vibration peak of hydroxyl groups at 3000 cm⁻¹ to 3600 cm⁻¹. A peak intensity of the stretching vibration peak at 100° C. is I₁, and a peak intensity of the stretching vibration peak at 30° C. is I₂, satisfying: I_{OH}=I₁/I₂, and I_{OH} 1.1. In some embodiments of this application, 1.15≤I_{OH}≤2. For example, the value of I_{OH} may be 1.1, 1.15, 1.2, 1.3, 1.35, 1.4, 1.55, 1.68, 1.74, 1.85, 1.91, 2, or a value falling within a range formed by any two thereof. In the infrared spectrum of the hydroxyl-modified binder, the intensity of the stretching vibration peak of hydroxyl groups at 3000 cm⁻¹ to 3600 cm⁻¹ reflects the hydroxyl content in the hydroxyl-modified binder. The I_{OH} value represents the variation of intensity of the hydroxyl peak with temperature. The larger the value of I_{OH}, the larger the number of hydroxyl groups capable of providing repairable hydrogen bonds, indicating a stronger self-healing function of the hydroxyl-modified binder. Conversely, a smaller value indicates a weaker self-healing function. The I_{OH} value falling within the above range indicates that the hydroxyl content in the hydroxyl-modified binder changes with temperature, and demonstrates that the modified binder possesses excellent self-healing properties, thereby improving the cycling expansion performance and low-voltage storage safety of the secondary battery.

In some embodiments of this application, as tested by means of cyclic voltammetry, during a charge-discharge cycle of the hydroxyl-modified binder cycled at a voltage of 0 V to 3.3 V, a weakest current signal value of hydrogen is Q₁ A, and a strongest current signal value of hydrogen is Q₂ A, satisfying: Qᵥ=Q₁/Q₂, and 0.8≤Qᵥ≤0.9. For example, the value of Q, may be 0.8, 0.82, 0.85, 0.86, 0.88, 0.9, or a value falling within a range formed by any two thereof. The Qᵥ value falling within the above range indicates that the amount of gas generated by the secondary battery during cycling and low-voltage storage is small, and demonstrates excellent cycling expansion performance and low-voltage storage safety performance.

In this application, the hydrogen current signal value of the hydroxyl-modified binder is measured by cyclic voltammetry. Specifically, the hydrogen current signal value may be measured according to the following steps: coating copper foil with the hydroxyl-modified binder to form a working electrode, on which the coating thickness of the binder is 10 m to m; using a lithium sheet as a counter electrode, and disposing a separator between the working electrode and the counter electrode; injecting an electrolyte solution, and then assembling the electrodes to obtain a coin cell; performing a charge-discharge test on the coin cell within a potential window of 0 to 3.3 V according to cyclic voltammetry, and performing differential electrochemical mass spectrometry (DEMS) to collect the gas generated during charge-discharge cycling within a voltage window of 0 V to 3.3 V; and converting the gas into a gas current signal; recording the weakest current signal value of hydrogen, denoted as Q₁ A, and the strongest current signal value, denoted as Q₂ A during the charge-discharge cycling within the voltage window of 0 V to 3.3 V Qᵥ=Q₁/Q₂, where Qᵥ represents the gas production of the hydroxyl-modified binder during the charge-discharge cycling. A larger value of Qᵥ indicates less gas production, and a smaller value of Qᵥ indicates more gas production.

In some embodiments of this application, the Young's modulus of the film of the hydroxyl-modified binder is 1.2 GPa to 7 GPa. For example, the Young's modulus of the film of the hydroxyl-modified binder may be 1.2 GPa, 2 GPa, 3 GPa, 4 GPa, 5 GPa, 6 GPa, 7 GPa, or a value falling within a range formed by any two thereof. The dimensions of the film of the hydroxyl-modified binder may be 0.8 cm wide×1 cm long×0.01 cm thick. The fact that the Young's modulus of the film of the hydroxyl-modified binder falls within the above range indicates that the hydroxyl-modified binder is of high toughness and can favorably exert its self-healing properties. Applying such binder to a negative electrode plate can alleviate the problem of interfacial pulverization during cycling of the negative electrode plate, thereby improving the cycling expansion performance of the secondary battery.

In some embodiments of this application, the elongation-at-break of the film of the hydroxyl-modified binder is 12% to 85%. For example, the elongation-at-break of the film of the hydroxyl-modified binder may be 12%, 14%, 16%, 20%, 30%, 40%, 50%, 60%, 75%, 85%, or a value falling within a range formed by any two thereof. The dimensions of the film of the hydroxyl-modified binder may be 1 cm wide×2 cm long×0.01 cm thick. The fact that the elongation-at-break of the film of the hydroxyl-modified binder falls within the above range indicates that the hydroxyl-modified binder is of high toughness and can favorably exert its self-healing properties. Applying such binder to a negative electrode plate can alleviate the problem of interfacial pulverization during cycling of the negative electrode plate, thereby improving the cycling expansion performance of the secondary battery.

In some embodiments of this application, the weight-average molecular weight, denoted as Mw, of the hydroxyl-modified binder is 100,000 g/mol to 750,000 g/mol. For example, Mw may be 100,000 g/mol, 200,000 g/mol, 300,000 g/mol, 400,000 g/mol, 500,000 g/mol, 600,000 g/mol, 700,000 g/mol, 750,000 g/mol, or a value falling within a range formed by any two thereof. Controlling Mw to fall within the above range can improve the tolerance of the binder to an electrolyte solution when superior adhesion properties and dispersion properties are achieved at the same time. Further, the above setting can impart high cohesion to the negative electrode material layer, and improve the adhesion between the negative electrode material layer and the negative current collector, thereby reducing the risk of detachment of the negative electrode material layer, and improving the cycling expansion performance of the secondary battery.

A second aspect of this application provides a method for preparing the hydroxyl-modified binder provided in the first aspect of this application. The method includes the following steps:
(1) dissolving the second monomer in a solvent and stirring under protection of an inert atmosphere to obtain a deoxygenated solution;
(2) adding a free-radical initiator into the deoxygenated solution, and then adding the first monomer under protection of an inert atmosphere to perform a copolymerization reaction to obtain a mixed solution containing the hydroxyl-modified binder; and
(3) stirring the mixed solution under negative pressure to remove monomers and isolate the hydroxyl-modified binder.

The solvent includes at least one of deionized water, ethanol, or acetone. The mass ratio of the second monomer to the solvent is 1:(1000 to 5000). For example, the mass ratio of the second monomer to the solvent may be 1:1000, 1:2000, 1:2500, 1:3000, 1:4000, 1:5000, or a value falling within a range formed by any two thereof. The mass ratio of the second monomer to the free-radical initiator is 1:(0.1 to 2). For example, the mass ratio of the second monomer to the free-radical initiator may be 1:0.1, 1:0.5, 1:0.8, 1:1, 1:1.2, 1:1.5, 1:1.8, 1:2, or a value falling within a range formed by any two thereof. Based on a total mass of the first monomer and the second monomer, the mass percent of the first monomer is 5% to 60%, and the mass percent of the second monomer is 40% to 90%. For example, the mass percent of the first monomer may be 5%, 8%, 10%, 14.2%, 7%, 20%, 23%, 26%, 30%, 33%, 35%, 37%, 40%, 48%, 50%, 55%, 60%, or a value falling within a range formed by any two thereof. The mass percent of the second monomer may be 40%, 48%, 50%, 55%, 60%, 62%, 69%, 70%, 75%, 78%, 80%, 85%, 88%, 90%, or a value falling within a range formed by any two thereof. The copolymerization reaction is performed at a temperature of 50° C. to 80° C. for a duration of 2 hours (h) to 8 hours. For example, the copolymerization reaction temperature may be 50° C., 60° C., 65° C., 70° C., 80° C., or a value falling within a range formed by any two thereof, and the copolymerization duration may be 2 h, 3 h, 4 h, 5 h, 6 h, 7 h, 8 h, or a value falling within a range formed by any two thereof. The negative pressure may be −0.1 MPa to −0.07 MPa; and the monomer removal time may be 1 h to 5 h. For example, the negative pressure may be −0.1 MPa, −0.2 MPa, −0.3 MPa, −0.4 MPa, −0.5 MPa, −0.6 MPa, −0.07 MPa, or a value falling within a range formed by any two thereof, and the monomer removal time may be 1 h, 2 h, 3 h, 4 h, 5 h, or a value falling within a range formed by any two thereof.

By using the above preparation method and sequentially adding the second monomer, the free-radical initiator, and the first monomer according to the above steps, this application can reduce the proportions of block structures and random structures in the molecular chain of the copolymer, increase the proportion of alternating structures in the molecular chain of the copolymer, and distribute the second monomer units uniformly in the molecular chain of the polymer, thereby improving the adhesion of copolymer chain segments to the negative active material, and exerting the self-healing effect of the hydroxyl-modified binder more efficiently. In addition, by controlling the mass ratio of the second monomer to the solvent, the mass ratio of the second monomer to the free-radical initiator, the mass percent of the first and second monomers, and the temperature and time of copolymerization reaction to fall within the ranges specified herein, this application achieves more uniform distribution of the second monomer units within the molecular chain of the polymer, enhancing the adhesion of copolymer chain segments to the negative active material, and exerting the self-healing effect of the hydroxyl-modified binder more efficiently. The hydroxyl-modified binder prepared using the above method possesses excellent self-healing properties, and can regenerate its original structure. Applying the hydroxyl-modified binder to a negative electrode plate of a secondary battery not only alleviates continuous expansion and contraction of the silicon negative electrode system during cycling, but also alleviates the problem of swelling during cycling and low-voltage storage of the secondary battery, thereby improving the cycling expansion performance and low-voltage storage safety performance of the secondary battery.

In step (1), the inert atmosphere includes at least one of argon or nitrogen. The time, temperature, and speed of stirring under protection of the inert atmosphere is not particularly limited, as long as the second monomer is dispersed uniformly. For example, the stirring time may be 3 to 8 hours, the stirring temperature may be room temperature, and the stirring speed may be 10 to 30 rpm.

In step (2), the free-radical initiator may include, but is not limited to, at least one of. (i) inorganic peroxides, such as sodium persulfate, potassium persulfate, ammonium persulfate, a composite initiator of ammonium persulfate and sodium bisulfite, potassium perphosphate, and hydrogen peroxide; (ii) organic peroxides, such as tert-butyl peroxide, cumene hydroperoxide, terpinyl hydroperoxide, di-tert-butyl peroxide, tert-butyl cumyl peroxide, acetyl peroxide, isobutyl peroxide, octanoyl peroxide, dibenzoyl peroxide, 3,5,5-trimethylhexanol peroxide, and tert-butyl peroxyisobutyrate; or (iii) azo compounds, such as azobisisobutyronitrile, azo-bis-2,4-dimethylvaleronitrile, azodicyclohexanecarbonitrile, and dimethyl azodiisobutyrate. In this application, when the first monomer is added to the deoxygenated solution, in order to control the reaction rate and enable the second monomer unit to be distributed more uniformly in the molecular chain of the polymer, the first monomer may be added dropwise. The dropwise adding rate is not particularly limited, as long as the objectives of this application can be achieved. For example, the dropwise adding rate is 0.1 mL/s to 1 mL/s.

In step (3), the stirring speed is not particularly limited herein, as long as the objectives of this application can be achieved. For example, the stirring speed may be 10 rpm to 30 rpm. The method for isolating the binder is not particularly limited herein, and any isolation method commonly used in the art may be employed, as long as the objectives of this application can be achieved. For example, the binder may be isolated by extraction, but the isolation method is not limited to extraction. In step (3), after the monomers are removed by stirring the mixed solution under a negative pressure, the resulting hydroxyl-modified binder is dispersed in the unreacted solvent, and exists in the form of a hydroxyl-modified binder emulsion. The solid content of the emulsion may be adjusted to a suitable level, and the emulsion is used directly for preparing a negative electrode slurry. Those skilled in the art may also dry the emulsion according to actual needs to obtain solid particles of the hydroxyl-modified binder. In preparing a negative electrode plate, the above solvent is added to formulate a composition of the hydroxyl-modified binder and solvent. This is not particularly limited herein, as long as the objectives of this application can be achieved. The drying may be performed at a temperature of 80° C. to 120° C. for a duration of 2 h to 10 h.

This application further provides a hydroxyl-modified binder composition. The binder composition includes the hydroxyl-modified binder provided in the first aspect of this application and a solvent. Based on the mass of the hydroxyl-modified binder composition, the mass percent of the hydroxyl-modified binder is 5% to 7%, and the mass percent of the solvent is 93% to 95%. For example, the mass percent of the hydroxyl-modified binder may be 5%, 5.5%, 6%, 6.5%, 7%, or a value falling within a range formed by any two thereof; and the mass percent of the solvent may be 93%, 93.5%, 94%, 94.5%, 95%, or a value falling within a range formed by any two thereof. The solvent includes at least one of deionized water, ethanol, or acetone. With a negative electrode plate prepared by using the hydroxyl-modified binder composition satisfying the above characteristics, the hydroxyl-modified binder can be more uniformly dispersed in the negative electrode material layer, thereby more efficiently exerting the function of the hydroxyl-modified binder, and improving the cycling expansion performance and low-voltage storage safety performance of the secondary battery.

A third aspect of this application provides a secondary battery. The secondary battery includes a negative electrode plate. The negative electrode plate includes a negative current collector and a negative electrode material layer disposed on at least one surface of the negative current collector. The negative electrode material layer includes a negative active material. The negative active material includes a silicon-containing material. The negative electrode material layer further includes the hydroxyl-modified binder provided in the first aspect hereof or a hydroxyl-modified binder prepared using the preparation method provided in the second aspect hereof. The secondary battery uses the above hydroxyl-modified binder as a binder in the negative electrode material, without containing components of excessively high hydroxyl reactivity such as polyvinyl alcohol, thereby imparting strong adhesion to the negative electrode plate and achieving self-healing properties. This not only alleviates continuous expansion and contraction of the silicon negative electrode system during cycling, but also alleviates the problem of swelling during cycling and low-voltage storage of the secondary battery, thereby improving the cycling expansion performance and low-voltage storage safety performance of the secondary battery.

In some embodiments of this application, the silicon-containing material includes at least one of silicon, a silicon-carbon compound, or a silicon-oxygen compound. Based on a mass of the negative electrode material layer, a mass percentage of silicon is M %, satisfying: 0.5≤M≤60, and preferably 5≤M≤40. For example, the value of M may be 0.5, 3, 5, 8, 10, 12, 15, 17, 20, 30, 40, 50, 60, or a value falling within a range formed by any two thereof. Selecting the silicon-containing material within the above range and controlling the mass percent of silicon to fall within the above range endow the secondary battery with a relatively high energy density, and make it more convenient to exert the self-healing effect of the hydroxyl-modified binder in the silicon negative electrode system, thereby improving the cycling expansion performance and low-voltage storage safety performance of the secondary battery.

Generally, the mass percent M % of silicon in the negative electrode material layer may be adjusted by adjusting either the mass percent of the silicon-containing material in the negative electrode material layer or the mass percent of silicon in the silicon-containing material. With the silicon mass percent kept constant in the silicon-containing material, an increased mass percent of the silicon-containing material in the negative electrode material layer increases M %, and a reduced mass percent of the silicon-containing material in the negative electrode material layer decreases M %. With the mass percent of the silicon-containing material kept constant in the negative electrode material layer, an increased mass percent of silicon in the silicon-containing material increases M %, and a reduced mass percent of silicon in the silicon-containing material decreases M %.

In some embodiments of this application, based on a mass of the negative electrode material layer, a mass percentage of the hydroxyl-modified binder is N %, satisfying: 1.2≤N≤11.5, and preferably 1.2≤N≤8. For example, the value of N may be 1.2, 2, 4, 5, 6, 8, 10, 11.5, or a value falling within a range formed by any two thereof. By controlling the mass percent of the hydroxyl-modified binder to fall within the above range, this application achieves strong adhesion between particles of the negative active material, exerts the self-healing effect of the hydroxyl-modified binder in the silicon negative electrode system, endows the negative electrode material layer with a relatively high gravimetric capacity, thereby endowing the secondary battery with a relatively high energy density and excellent cycling expansion performance and low-voltage storage safety performance.

In some embodiments of this application, based on the mass of the negative electrode material layer, the mass percent of the hydroxyl-modified binder is N %, satisfying: 0.12≤N/M≤3.2, and preferably 0.24≤N/M≤1.6. For example, the value of N/M may be 0.12, 0.24, 0.4, 0.5, 1, 1.3, 1.6, 1.75, 2.1, 2.3, 2.5, 3.2, or a value falling within a range formed by any two thereof. With the N/M ratio value controlled within the above range, the synergistic effect between the hydroxyl-modified binder and the silicon in the negative electrode material layer is strong, the self-healing function of the hydroxyl-modified binder in the silicon negative electrode system is exerted more efficiently, so that the secondary battery achieves a relatively high energy density and higher levels of cycling expansion performance and low-voltage storage safety performance.

In this application, the negative electrode material layer may be disposed on one surface of the negative current collector in a thickness direction or on both surfaces of the negative current collector in the thickness direction. It is hereby noted that the “surface” here may be the entire region of the negative current collector, or a partial region of the negative current collector, without being particularly limited herein, as long as the objectives of the application can be achieved. The thicknesses of the negative current collector and the negative electrode material layer are not particularly limited herein, as long as the objectives of this application can be achieved. For example, the thickness of the negative current collector is 4 μm to 12 μm, and the thickness of the negative electrode material layer on a single side is 30 μm to 160 μm.

In this application, the negative electrode material layer may further include graphite, a conductive agent, and a dispersant. In this application, the conductive agent is not particularly limited, as long as the objectives of this application can be achieved. For example, the conductive agent may include, but is not limited to, at least one of conductive carbon black (Super P), carbon nanotubes (CNTs), graphite, carbon fiber, carbon nanowire, graphene, a metal material, or a conductive polymer. The carbon nanotubes may include, but are not limited to, single-walled carbon nanotubes and/or multi-walled carbon nanotubes. The carbon fibers may include, but are not limited to, vapor grown carbon fibers (VGCF) and/or carbon nanofibers. The metal material may include, but is not limited to, metal powder and/or metal fibers. Specifically, the metal may include, but is not limited to, at least one of copper, nickel, aluminum, or silver. The conductive polymer may include, but is not limited to, at least one of polyphenylene derivatives, polyaniline, polythiophene, polyacetylene, or polypyrrole. The dispersant may include sodium carboxymethyl cellulose. Based on the mass of the negative electrode material layer, the mass percent of graphite is 0% to 88%, the mass percent of the silicon-containing material is 10% to 98%, the mass percent of the conductive agent is 0.1% to 1.5%, and the mass percent of the dispersant is 0.3% to 1.5%.

The method for preparing the negative electrode plate is not particularly limited herein, as long as the objectives of this application can be achieved. For example, the negative electrode plate may be prepared using the following method: dispersing the hydroxyl-modified binder in a solvent to formulate a binder slurry in which the solid content is 5% to 7%; mixing a negative active material, a conductive agent, and a dispersant; adding the binder slurry, and then adding the mixture into a solvent, and stirring well to obtain a negative electrode slurry in which the solid content is 15 wt % to 45 wt %. Applying the negative electrode slurry evenly on one surface of the negative current collector, and oven-drying the slurry to obtain a negative electrode plate coated with a negative electrode material layer on a single side. Subsequently, repeating the above coating steps on the other surface of the negative current collector, and oven-drying the current collector to obtain a negative electrode plate coated with a negative electrode material layer on both sides. Cold-pressing and cutting the coated negative electrode plate to obtain a negative electrode plate.

The secondary battery of this application further includes a positive electrode plate. The positive electrode plate is not particularly limited herein, as long as the objectives of this application can be achieved. For example, the positive electrode plate includes a positive current collector and a positive electrode material layer disposed on at least one surface of the positive current collector. In this application, the positive electrode material layer may be disposed on one surface of the positive current collector in a thickness direction or on both surfaces of the positive current collector in the thickness direction. It is hereby noted that the “surface” here may be the entire region of the surface of the positive current collector, or a partial region of the surface of the positive current collector, without being particularly limited herein, as long as the objectives of the application can be achieved. The positive current collector is not particularly limited herein, as long as the objectives of this application can be achieved. For example, the positive current collector may include aluminum foil, aluminum alloy foil, a composite current collector (such as an aluminum carbon composite current collector), or the like. The thicknesses of the positive current collector and positive electrode material layer are not particularly limited herein, as long as the objectives of this application can be achieved. For example, the thickness of the positive current collector is 5 m to 20 m. The thickness of the positive electrode material layer on a single side is 30 m to 120 m.

In this application, the positive electrode material layer includes a positive active material. The type of the positive active material is not particularly limited herein as long as the objectives of this application can be achieved. The positive active material may include at least one of lithium nickel cobalt manganese oxide (such as NCM811, NCM622, NCM523, NCM111), lithium nickel cobalt aluminum oxide, lithium iron phosphate, a lithium-rich manganese-based material, lithium cobalt oxide, lithium manganese oxide, lithium manganese iron phosphate, or the like. The positive electrode material layer in this application may further include a conductive agent and a binder. The conductive agent is not particularly limited herein, as long as the objectives of this application can be achieved. For example, the conductive agent may include, but is not limited to, at least one of conductive carbon black (Super P), carbon nanotubes, flake graphite, carbon fiber, graphene, amorphous carbon, hard carbon, soft carbon, glassy carbon, carbon nanofiber, a metal material, or a conductive polymer. The conductive carbon black may include, but is not limited to, at least one of acetylene black or Ketjen black. The carbon nanotubes may include, but are not limited to, single-walled carbon nanotubes and/or multi-walled carbon nanotubes. The carbon fibers may include, but are not limited to, vapor grown carbon fibers (VGCF) and/or carbon nanofibers. The metal material may include, but is not limited to, metal powder and/or metal fibers. Specifically, the metal may include, but is not limited to, at least one of copper, nickel, aluminum, or silver. The conductive polymer may include, but is not limited to, at least one of polyphenylene derivatives, polyaniline, polythiophene, polyacetylene, or polypyrrole. The binder is not particularly limited herein, as long as the objectives of this application can be achieved. For example, the binder may include, but is not limited to, at least one of polyacrylic acid, polyacrylic acid sodium, polyacrylic acid potassium, polyacrylic acid lithium, polyimide, polyvinyl alcohol, carboxymethyl cellulose, sodium carboxymethyl cellulose, lithium carboxymethyl cellulose, polyamide imide, styrene butadiene rubber, or polyvinylidene difluoride.

The method for preparing the positive electrode plate is not particularly limited herein as long as the objectives of this application can be achieved. For example, the positive electrode plate may be prepared by the following method: mixing a positive active material, a conductive agent, and a binder, adding N-methylpyrrolidone (NMP), and stirring well to obtain a positive electrode slurry in which the solid content is 65 wt % to 85 wt %. Applying the positive electrode slurry evenly onto one surface of the positive current collector, and oven-drying the slurry to obtain a positive electrode plate coated with a positive electrode material layer on a single side. Subsequently, repeating the above coating steps on the other surface of the positive current collector, and oven-drying the current collector to obtain a positive electrode plate coated with a positive electrode material layer on both sides. Cold-pressing and cutting the coated positive electrode plate to obtain a positive electrode plate. The mass ratio between the positive active material, the conductive agent, and the binder in the positive electrode material layer is not particularly limited herein, as long as the objectives of this application can be achieved.

The secondary battery according to this application further includes an electrolyte solution. The electrolyte solution in this application may include a lithium salt and a nonaqueous solvent. The type of the lithium salt is not particularly limited herein as long as the objectives of this application can be achieved. For example, the lithium salt may include, but is not limited to, at least one of lithium hexafluorophosphate (LiPF₆), lithium tetrafluoroborate (LiBF₄), lithium difluorophosphate (LiPO₂F₂), lithium bis(trifluoromethanesulfonyl)imide (LiTFSI), lithium bis(fluorosulfonyl)imide (LiFSI), lithium bis(oxalato)borate (LiBOB), or lithium difluoro(oxalato)borate (LiDFOB). The type of the nonaqueous solvent is not particularly limited herein, as long as the objectives of this application can be achieved. For example, the nonaqueous solvent may include, but is not limited to, at least one of a carbonate compound, a carboxylate compound, an ether compound, or other nonaqueous solvents. The carbonate compound may include, but is not limited to, at least one of a chain carbonate compound or a cyclic carbonate compound. The chain carbonate compound may include, but is not limited to, at least one of dimethyl carbonate, diethyl carbonate (DEC), dipropyl carbonate, methyl propyl carbonate, ethylene propyl carbonate, or ethyl methyl carbonate. The cyclic carbonate ester compound may include, but is not limited to, at least one of ethylene carbonate (EC), propylene carbonate (PC), butylene carbonate, or vinyl ethylene carbonate. The carboxylate compound may include, but is not limited to, at least one of methyl formate, methyl acetate, ethyl acetate, n-propyl acetate, tert-butyl acetate, methyl propionate, ethyl propionate (EP), propyl propionate, γ-butyrolactone, decanolactone, valerolactone, or caprolactone. The ether compound may include, but is not limited to, at least one of ethylene glycol dimethyl ether, dibutyl ether, tetraglyme, diglyme, 1,2-dimethoxyethane, 1,2-diethoxyethane, 1-ethoxy-1-methoxyethane, 2-methyltetrahydrofuran, or tetrahydrofuran. The above-mentioned other nonaqueous solvents may include, but are not limited to, at least one of dimethyl sulfoxide, 1,2-dioxolane, sulfolane, methyl sulfolane, 1,3-dimethyl-2-imidazolidinone, N-methyl-2-pyrrolidone, dimethylformamide, acetonitrile, trimethyl phosphate, triethyl phosphate, or trioctyl phosphate.

The secondary battery of this application further includes a separator. The separator is not particularly limited herein, as long as the objectives of this application can be achieved. For example, the separator may be made of a material including but not limited to at least one of: a polyethylene (PE)- or polypropylene (PP)-based polyolefin (PO), a polyester (such as polyethylene terephthalate (PET) film), cellulose, polyimide (PI), polyamide (PA), spandex, or aramid. The type of the separator may include a woven film, a nonwoven film, a microporous film, a composite film, a calendered film, or a spinning film. In some embodiments, the separator may include a substrate layer and a surface treatment layer. The substrate layer may be a nonwoven fabric, film, or composite film, which, in each case, assumes a porous structure. The material of the substrate layer may include at least one of polyethylene, polypropylene, polyethylene terephthalate, or polyimide. Optionally, the substrate layer may be a polypropylene porous film, a polyethylene porous film, a polypropylene non-woven fabric, a polyethylene non-woven fabric, or a polypropylene-polyethylene-polypropylene porous composite film. Optionally, the surface treatment layer is disposed on at least one surface of the substrate layer. The surface treatment layer may be a polymer layer or an inorganic compound layer, or a layer compounded of a polymer and an inorganic compound. In some embodiments, the inorganic compound layer includes inorganic particles and a binder. The inorganic particles are not particularly limited herein. For example, the inorganic particles may include at least one of aluminum oxide, silicon oxide, magnesium oxide, titanium oxide, hafnium dioxide, tin oxide, ceria, nickel oxide, zinc oxide, calcium oxide, zirconium oxide, yttrium oxide, silicon carbide, boehmite, aluminum hydroxide, magnesium hydroxide, calcium hydroxide, or barium sulfate. The binder is not particularly limited herein. For example, the binder may be at least one of the above-mentioned binders. In some embodiments of this application, the polymer layer includes a polymer. The material of the polymer includes at least one of polyamide, polyacrylonitrile, acrylate polymer, polyacrylic acid, polyacrylate, polyvinylpyrrolidone, polyvinyl ether, polyvinylidene fluoride, or poly(vinylidene fluoride-co-hexafluoropropylene). In this application, the thickness of the separator is not particularly limited herein, as long as the objectives of this application can be achieved. For example, the thickness of the separator may be 3 μm to 30 μm.

The secondary battery further includes a housing. The housing is configured to accommodate a positive electrode plate, a separator, a negative electrode plate, an electrolyte solution, and other components known in the art for use in the secondary battery. The other components are not limited herein. The housing is not particularly limited herein, and may be a housing well-known in the art, as long as the objectives of this application can be achieved. For example, the housing may be a hard housing or a flexible housing. The material of the hard housing may be metal. The type of the metal is not limited herein. The hard housing may be a metallic hard housing known in the art as long as the objectives of this application can be achieved. The flexible housing may be a metallic laminated film such as an aluminum laminated film, a steel laminated film.

The process of preparing the secondary battery of this application is well known to a person skilled in the art, and is not particularly limited herein. For example, the preparation process of the secondary battery may include, but is not limited to, the following steps: stacking the positive electrode plate, the separator, and the negative electrode plate in sequence, performing operations as required such as winding and folding to obtain a jelly-roll electrode assembly, putting the electrode assembly into a housing, injecting the electrolyte solution into the housing, and sealing the housing to obtain a secondary battery. Alternatively, the steps are as follows: stacking the positive electrode plate, the separator, and the negative electrode plate in sequence, and then fixing the four corners of the entire stacked structure by use of adhesive tape to obtain a stacked-type electrode assembly, putting the electrode assembly into a housing, injecting the electrolyte solution into the housing, and sealing the housing to obtain a secondary battery. In addition, an overcurrent protection element, a conductive plate, and the like as required may be placed into a housing, so as to prevent the rise of internal pressure, overcharge, and overdischarge of the secondary battery.

The secondary battery is not particularly limited in this application, and may be any device in which an electrochemical reaction occurs. For example, the types of the secondary battery may include, but are not limited to, a lithium metal secondary battery, a lithium-ion secondary battery (lithium-ion battery), a lithium polymer secondary battery, or a lithium-ion polymer secondary battery.

A fourth aspect of this application provides an electronic device. The electronic device includes the secondary battery according to the third aspect of this application. Therefore, the electronic device of this application exhibits a relatively long lifespan.

The type of the electronic device is not particularly limited herein, and may be any electronic device known in the prior art. In some embodiments of this application, the types of the electronic device may include, but are not limited to, a laptop computer, pen-inputting computer, mobile computer, e-book player, portable phone, portable fax machine, portable photocopier, portable printer, stereo headset, video recorder, liquid crystal display television set, handheld cleaner, portable CD player, mini CD-ROM, transceiver, electronic notepad, calculator, memory card, portable voice recorder, radio, backup power supply, motor, automobile, motorcycle, power-assisted bicycle, bicycle, lighting appliance, toy, game console, watch, electric tool, flashlight, camera, large household storage battery, lithium-ion capacitor, or the like.

### EMBODIMENTS

The implementations of this application are described below in more detail with reference to some embodiments and comparative embodiments. Various tests and evaluations are performed by the following methods. In addition, unless otherwise specified, the word “parts” means parts by mass, and the symbol “%” means a percentage by mass.

### Test Methods and Devices

### Determination of Mass Percent of Monomer Units in a Polymer

Using a pyrolysis gas chromatography mass spectrometry (pyGC-MS) instrument to pyrolyze a polymer, and determining the monomers of the pyrolyzed polymer. Determining the mass percent of the monomer units in the polymer through analysis. Drying a hydroxyl-modified binder in an 80° C. oven for 8 h. Testing the dried hydroxyl-modified binder in the pyGC-MS instrument, where the instrument model is Agilent 7890B/5977B, the detector is a mass selective detector (MSD), the injector is a pyrolyzer EGA/PY-3030D, the column oven temperature is 40° C. to 320° C., and the pyrolyzer temperature is 40° C. to 800° C.

### Test of Viscosity

Dispersing a hydroxyl-modified binder in water by stirring for 2 minutes at a temperature of 25° C. and a stirring speed of 12 rpm to form an aqueous dispersion in which the mass percent of the hydroxyl-modified binder is 6%. Measuring the viscosity of the aqueous dispersion of the hydroxyl-modified binder by use of a digital rotational viscometer (Shanghai Jingtian Electronic Instrument Co., Ltd., LVDV-1). Selecting a rotor and a rotation speed as appropriate for the aqueous dispersion of the binder to be measured. Tilting and immersing the rotor slowly in the aqueous dispersion of the binder to allow wetting, and ensuring that air bubbles do not form at the bottom of the rotor. Starting the rotational viscometer when the liquid level of the aqueous dispersion of the binder reaches a middle position of the groove of the rotor. Waiting for three minutes until the readout keeps constant, and recording the readout as a viscosity of the aqueous dispersion of the binder in units of mPa s.

### Infrared Spectroscopy Test

Measuring the infrared spectra of the hydroxyl-modified binder at 30° C. and 100° C. separately by use of a Fourier transform infrared spectrometer.

### Qᵥ Test

Coating 6 μm-thick copper foil with the binder prepared in each embodiment or comparative embodiment to make a working electrode, where the coating thickness is 15 m. Making a negative electrode steel shell, a spring sheet, and a positive electrode steel shell readily available. Using a lithium sheet as a counter electrode, and using a polyethylene film as a separator. Stacking the negative electrode steel shell, the spring sheet, the working electrode, the separator, the counter electrode, and the positive electrode steel shell in sequence, injecting an electrolyte solution, and then assembling the electrodes to form a coin cell. The electrolyte solution, the copper foil, and the separator used here are the same as those in Embodiment 1-1.

Performing a charge-discharge test on the coin cell in an electrochemical workstation (model: 1470E/1455, supplied by Solartron) by means of cyclic voltammetry, where the voltage window is set to 0 V to 3.3 V, the scan rate is 0.1 mV/s, and the number of cycles is 3. At the same time, using a differential electrochemical mass spectrometer (DEMS)(model: HPR-40, supplied by Hiden Analytical) to collect the gas generated during the cycling, converting the gas into current signals of the gas, and collecting the current signal of hydrogen. Recording the strongest hydrogen signal value as Q₁ (A), and recording the weakest hydrogen signal value as Q₂ (A). Qᵥ=Q₁/Q₂.

### Test of the Young's Modulus and Elongation-at-Break

Casting a hydroxyl-modified binder slurry into a mold, and then drying the hydroxyl-modified binder slurry in an oven at 80° C. for 4 h to obtain a film. Measuring the Young's modulus (E) and the elongation-at-break of the film of the hydroxyl-modified binder using a universal tensile tester.

Measuring the Young's modulus according to the international standard ASTM E111-04 (2010) Standard Test Methods for Young's Modulus, Tangent Modulus, and Chord Modulus. Cutting the film of the hydroxyl-modified binder into specimens of 0.8 cm×1 cm×0.01 cm in size. Clamping a specimen between an upper grip and a lower grip of a universal tensile tester, and measuring the stress σ and strain ε of the specimen under conditions including: amplitude 10 m, frequency 1 Hz, conditioning time 2 min, test time 5 min, preload 0.1 N, and tensile angle 180°. Calculating the Young's modulus according to Hooke's Law, E=σ/ε, in GPa.

Measuring the elongation-at-break according to the Chinese national standard GB/T 30776-2014 Test Method for Tensile Strength and Elongation at break of Adhesive Tapes. Cutting the film of the hydroxyl-modified binder into specimens of 1 cm (length)×2 cm (width)×0.01 cm (height). Clamping a specimen between an upper grip and a lower grip of the universal tensile tester, where an initial distance between the fixed upper grip and lower grip is L₀, an initial length of the specimen is L₀. Pulling the upper and lower grips at a constant rate of 50 mm/min until the specimen breaks. Recording the distance between the upper grip and the lower grip at the moment of break of the specimen as L₁. Calculating the elongation-at-break as: L=(L₁−L₀)/L₀×100%.

### Test of Weight-Average Molecular Weight

Using gel permeation chromatography (GPC) to characterize the weight-average molecular weight (Mw) of the hydroxyl-modified binder, where the GPC instrument is an Agilent 1260 HPLC gel chromatograph equipped with a refractive index detector (RID) and a 79911GP-502 chromatographic column. The specific procedures include: dispersing 5 mg of the hydroxyl-modified binder specimen in 2 mL of deionized water (HPLC grade), where the column temperature is 30° C., the mobile phase is HPLC-grade water, and the flow rate is 1.0 mL·min⁻¹.

### Test of Mass Percent of Silicon

Disassembling a lithium-ion battery, and taking out a negative electrode plate. Fixing the negative electrode plate to a specimen stage using conductive carbon adhesive, and placing the specimen stage onto a holder. Place the holder and the specimen stage into a cross-section polisher (CP), evacuating to 10⁻⁴ Pa, and then cutting the negative electrode plate specimen along the thickness direction of the negative electrode plate using argon gas. Placing the CP-cut specimen onto an SEM specimen stage, with the cross-section of the specimen facing upward. Observing the specimen using a Philips XL-30 field-emission scanning electron microscope (SEM), where the accelerating voltage is 10 kV, the emission current is 10 mA, and the magnification is 3000×. Measuring the mass percent M % of silicon in the negative electrode material layer using an energy-dispersive X-ray spectrometer (EDS) attached to the SEM.

### Test of Mass Percent of the Hydroxyl-Modified Binder

Discharging a lithium-ion battery at a current of 0.2 C until the voltage reaches 3.0 V, and repeating this step three times to prevent voltage rebound. Disassembling the lithium-ion battery in a drying room (in which the water content is less than 2%), and taking out a negative electrode plate. Cleaning the negative electrode plate using a dimethyl carbonate (DMC) solvent according to the following steps: soaking the negative electrode plate in DMC for 12 hours, ensuring complete immersion of the negative electrode plate in the liquid, and discarding the solvent after completion of soaking. Repeating the above cleaning steps 2 times. Drying the negative electrode plate in a 60° C. oven for 8 hours after completion of cleaning. Subsequently, scraping off a negative electrode material layer on the surface of the negative electrode plate, taking a specimen of the negative electrode material layer, and testing the specimen in a pyrolysis gas chromatography-mass spectrometer (pyGC-MS) instrument, where the instrument model is Agilent 7890B/5977B, the detector is a mass selective detector (MSD), the injector is a pyrolyzer EGA/PY-3030D, the column oven temperature is 40° C. to 320° C., and the pyrolyzer temperature is 40° C. to 800° C.

### Cycling Expansion Performance

Evaluating the cycling expansion performance of a lithium-ion battery by measuring the expansion rate of the lithium-ion battery cycled for 500 cycles. A lower expansion rate of the lithium-ion battery cycled for 500 cycles indicates superior cycling expansion performance. A higher expansion rate of the lithium-ion battery cycled for 500 cycles indicates inferior cycling expansion performance of the lithium-ion battery. Charging a lithium-ion battery at a constant current of 1.0 C at 25° C. until the voltage reaches 4.53 V that indicates a fully charged state, and then charging the battery at a constant voltage of 4.53 V until the current reaches a cut-off current 0.05 C. Subsequently, discharging the lithium-ion battery at a constant current of 0.7 C until the voltage tapers off to 3.0 V, thereby completing one charge-discharge cycle. Repeating the above operations for 500 cycles. Using a micrometer to measure the thickness of the lithium-ion battery when the battery is initially charged to 4.53 V, denoted as H₀. Measuring the thickness of the battery at the end of charging in the 500^{th} cycle, denoted as H₁. Taking the same measurement point on each battery for measurement, measuring the thickness at each measurement point three times, and using the average value as a test result. Expansion rate (%) of a lithium-ion battery cycled for 500 cycles=(H₁−H₀)/H₀×100%.

### Low-Voltage Storage Safety Performance

Evaluating the low-voltage storage safety performance of a lithium-ion battery by measuring the overdischarge gas-generation voltage of the lithium-ion battery. A lower overdischarge gas-generation voltage indicates superior low-voltage storage safety performance, and a higher overdischarge gas-generation voltage indicates inferior low-voltage storage safety performance. Charging a lithium-ion battery at a constant current of 1.0 C at 25° C. until the voltage reaches 4.53 V that indicates a fully charged state, and then charging the battery at a constant voltage of 4.53 V until the current reaches a cut-off current 0.05 C. Subsequently, discharging the lithium-ion battery at a constant current of 0.7 C until the voltage tapers off to 3.0 V, thereby completing one charge-discharge cycle. Repeating the above operations for 100 cycles. Charging the lithium-ion battery, which has undergone 100 cycles, at a constant current of 1.0 C until a full-charge voltage 4.53 V, and then connecting the battery to an instrument used for real-time monitoring of thickness and voltage, and discharging the battery at a constant current of 0.2 C until the voltage drops to 0 V. Recording the voltage at which the thickness change of the lithium-ion battery exceeds 10 m, which is an overdischarge gas-generation voltage, in units of V.

Understandably, when the voltage range marked on the outer packaging of a lithium-ion battery at shipment is 3.0 V to 4.53 V, the charge cut-off voltage is 4.53 V and the discharge cut-off voltage is 3.0 V It is noted that, in a lithium-ion battery used as an example in this application, the charge cut-off voltage is 4.53 V and the discharge cut-off voltage is 3.0 V, but this application is not limited thereto.

### Embodiment 1-1

### <Preparation of a Hydroxyl-Modified Binder>

(1) Dissolving a second monomer N-(2-hydroxyethyl)acrylamide (HEAA) in a deionized water solvent, and adding the mixed solution into a flask. Stirring the solution at 25° C. under argon protection for 5 hours to obtain a deoxygenated solution. In the solution, a mass ratio of the second monomer to the solvent is 1:2500.

(2) Adding a free-radical initiator (NH₄)₂S₂O₈/NaHSO₃ into the deoxygenated solution, and stirring for 10 minutes. Subsequently, transferring the first monomer acrylic acid into a funnel under argon protection, and then dripping the first monomer into the flask. Transferring the flask to a 60° C. constant-temperature oil bath after completion of dripping the first monomer, and stirring at a speed of 15 rpm for 2.5 h to carry out a copolymerization reaction to obtain a mixed solution containing a hydroxyl-modified binder. The mass ratio of the second monomer to the free-radical initiator is 1:0.1, and the copolymerization reaction is performed at a temperature of 60° C. for a duration of 2.5 h. Based on a total mass of the first monomer and the second monomer, the mass percent of the first monomer is 30%, and the mass percent of the second monomer is 70%. In the (NH₄)₂S₂O₈/NaHSO₃, the mass ratio of (NH₄)₂S₂O₈ to NaHSO₃ is 1:0.3.

(3) Stirring the mixed solution for 2.5 hours under a −0.5 MPa negative pressure at a speed of 15 rpm to remove monomers and obtain an aqueous dispersion of the hydroxyl-modified binder.

### <Preparation of a Negative Electrode Plate>

Using deionized water as a solvent, and formulating a negative electrode binder slurry with a solid content of 6 wt % using the above-prepared hydroxyl-modified binder.

Mixing a silicon-carbon compound (in which the mass ratio of silicon to carbon is 50:50), graphite, carbon black as a conductive agent, and sodium carboxymethyl cellulose (Mw=350,000) as a dispersant. Adding the binder slurry and stirring well, and then adding deionized water as a solvent to formulate a slurry with a solid content of 45 wt %. Stirring well in a vacuum mixer to obtain a negative electrode slurry. Applying the negative electrode slurry evenly onto one surface of 6 μm-thick negative current collector copper foil, and drying the foil at 120° C. to obtain a negative electrode plate coated with a negative electrode material layer on a single side, where the coating weight of the negative electrode material layer is 100 mg/1540 mm². Subsequently, repeating the above steps on the other surface of the copper foil to obtain a negative electrode plate coated with the negative electrode material layer on both sides. Drying the electrode plate at 120° C., and then performing cold-pressing, cutting, and tab welding to obtain a negative electrode plate of 78 mm×875 mm in size for future use. The thickness of the negative electrode material layer on a single side is 35 m. Based on the mass of the negative electrode material layer, the mass percent of the silicon-containing material is 10%, the mass percent of the conductive agent is 0.1%, the mass percent of the dispersant is 0.5%, the mass percent of the hydroxyl-modified binder is 2%, and the remainder is graphite. The mass percent of silicon, denoted as M %, is 5%.

### <Preparation of a Positive Electrode Plate>

Mixing lithium cobalt oxide as a positive active material, conductive carbon black as a conductive agent, and polyvinylidene fluoride as a binder at a mass ratio of 97.9:0.9:1.2, adding N-methyl-pyrrolidone (NMP) as a solvent to formulate a slurry in which the solid content is 75 wt %, and stirring well in vacuum to obtain a positive electrode slurry. Applying the positive electrode slurry evenly onto one surface of 10 μm-thick positive current collector aluminum foil, and drying the foil at 120° C. to obtain a positive electrode plate coated with a positive electrode material layer on a single side, where the coating weight of the positive electrode material layer is 267.8 mg/1540 mm². Subsequently, repeating the above steps on the other surface of the aluminum foil to obtain a positive electrode plate coated with the positive electrode material layer on both sides. Performing oven-drying at 120° C., and then performing cold-pressing, cutting, and tab welding to obtain a positive electrode plate of 74 mm×867 mm ready for use. The thickness of the positive electrode material layer on a single side is 42 m.

### <Separator>

Using a 15 μm-thick polyethylene film (supplied by Celgard) as a separator.

### <Preparation of an Electrolyte Solution>

Mixing dimethyl carbonate, diethyl carbonate, and ethylene carbonate at a mass ratio of 1:1:1 in an environment in which the water content is less than 10 ppm, and stirring well to obtain an organic solution. Subsequently, adding LiPF₆ as an electrolyte salt into the organic solvent, and stirring well to obtain an electrolyte solution. Based on the mass of the electrolyte solution, the mass percent of the electrolyte salt is 12.5%, and the remainder is the organic solvent.

### <Preparation of a Lithium-Ion Battery>

Stacking the prepared positive electrode plate, separator, and negative electrode plate in sequence such that the separator is located between the positive electrode plate and the negative electrode plate to serve a function of separation, and then winding the stacked structure to obtain an electrode assembly. Welding tabs to the electrode assembly, and then placing the electrode assembly into an aluminum laminated film packaging bag, and then dehydrating the packaged electrode assembly an 85° C. vacuum oven for 12 hours. Injecting the above-prepared electrolyte solution into the electrode assembly. Performing the steps such as vacuum sealing, standing, formation (charging the battery at a constant current of 0.02 C until the voltage reaches 3.5 V, and then charging the battery at a constant current of 0.1 C until the voltage reaches 3.9 V), shaping, capacity grading, and secondary packaging to obtain a lithium-ion battery.

### Embodiments 1-2 to 1-27

Identical to Embodiment 1-1 except that the relevant parameters are adjusted according to Table 1 and Table 2.

### Embodiments 2-1 to 2-15

Identical to Embodiment 1-1 except that the mass ratio of silicon to carbon in the silicon-containing material and/or the mass percent of the material are adjusted to make the mass percent M % of silicon compliant with Table 3, and the mass percent N % of the hydroxyl-modified binder is adjusted according to Table 3. When the mass percent of the silicon-containing material and/or the mass percent of the hydroxyl-modified binder changes, the mass percent of the graphite changes accordingly while the mass percent of the conductive agent and the dispersant remain unchanged.

### Comparative Embodiment 1

Identical to Embodiment 1-1 except that, in <Preparation of a negative electrode plate>, the hydroxyl-modified binder is replaced with a polyacrylic acid binder (PAA, Mw=300,000 g/mol).

### Comparative Embodiment 2

Identical to Embodiment 1-1 except that, in <Preparation of a negative electrode plate>, the hydroxyl-modified binder is replaced with a binder made of a mixture of polyvinyl alcohol (PVA, Mw=80,000 g/mol) and polyacrylic acid (PAA, Mw=300,000 g/mol). Based on the mass of the binder, the mass percent of the PVA is 80%, and the mass percent of the PAA is 20%.

### Comparative Embodiments 3 to 6

Identical to Embodiment 1-1 except that the relevant parameters are adjusted according to Table 1 and Table 2.

The relevant parameters and performance test results of each embodiment and comparative embodiment are shown in Table 1 to Table 3.

TABLE 1

| | Mass ratio of | Mass ratio of | | Mass percent | | |
|---|---|---|---|---|---|---|
| | second | second monomer | Mass percent of | of added | Copolymerization | |
| | monomer to | to free-radical | added first | second | reaction | Copolymerization |
| | solvent | initiator | monomer (%) | monomer (%) | temperature (° C.) | reaction time (h) |
| Embodiment | 1:2500 | 1:0.1 | 30 | 70 | 60 | 2.5 |
| 1-1 | | | | | | |
| Embodiment | 1:2500 | 1:0.1 | 5 | 95 | 60 | 2.5 |
| 1-2 | | | | | | |
| Embodiment | 1:2500 | 1:0.1 | 10 | 90 | 60 | 2.5 |
| 1-3 | | | | | | |
| Embodiment | 1:2500 | 1:0.1 | 40 | 60 | 60 | 2.5 |
| 1-4 | | | | | | |
| Embodiment | 1:2500 | 1:0.1 | 60 | 40 | 60 | 2.5 |
| 1-5 | | | | | | |
| Embodiment | 1:5000 | 1:0.1 | 30 | 70 | 60 | 2.5 |
| 1-6 | | | | | | |
| Embodiment | 1:1000 | 1:0.1 | 30 | 70 | 60 | 2.5 |
| 1-7 | | | | | | |
| Embodiment | 1:2500 | 1:1 | 30 | 70 | 60 | 2.5 |
| 1-8 | | | | | | |
| Embodiment | 1:2500 | 1:2 | 30 | 70 | 60 | 2.5 |
| 1-9 | | | | | | |
| Embodiment | 1:2500 | 1:0.1 | 30 | 70 | 50 | 2.5 |
| 1-10 | | | | | | |
| Embodiment | 1:2500 | 1:0.1 | 30 | 70 | 80 | 2.5 |
| 1-11 | | | | | | |
| Embodiment | 1:2500 | 1:0.1 | 30 | 70 | 60 | 2 |
| 1-12 | | | | | | |
| Embodiment | 1:2500 | 1:0.1 | 30 | 70 | 60 | 5 |
| 1-13 | | | | | | |
| Embodiment | 1:2500 | 1:0.1 | 30 | 70 | 60 | 8 |
| 1-14 | | | | | | |
| Embodiment | 1:2500 | 1:0.1 | 30 | 70 | 60 | 2.5 |
| 1-15 | | | | | | |
| Embodiment | 1:2500 | 1:0.1 | 30 | 70 | 60 | 2.5 |
| 1-16 | | | | | | |
| Embodiment | 1:2500 | 1:0.1 | 30 | 70 | 60 | 2.5 |
| 1-17 | | | | | | |
| Embodiment | 1:2500 | 1:0.1 | 30 | 70 | 60 | 2.5 |
| 1-18 | | | | | | |
| Embodiment | 1:2500 | 1:0.1 | 30 | 70 | 60 | 2.5 |
| 1-19 | | | | | | |
| Embodiment | 1:2500 | 1:0.1 | 60 | 40 | 60 | 2.5 |
| 1-20 | | | | | | |
| Embodiment | 1:2500 | 1:0.1 | 30 | 70 | 60 | 2.5 |
| 1-21 | | | | | | |
| Embodiment | 1:2500 | 1:0.1 | 30 | 70 | 60 | 2.5 |
| 1-22 | | | | | | |
| Embodiment | 1:2500 | 1:1 | 20 | 80 | 50 | 2 |
| 1-23 | | | | | | |
| Embodiment | 1:1000 | 1:0.1 | 60 | 40 | 80 | 8 |
| 1-24 | | | | | | |
| Embodiment | 1:2500 | 1:0.1 | 20 | 80 | 50 | 5 |
| 1-25 | | | | | | |
| Embodiment | 1:2500 | 1:1 | 10 | 90 | 80 | 2 |
| 1-26 | | | | | | |
| Embodiment | 1:2500 | 1:0.1 | 60 | 40 | 60 | 5 |
| 1-27 | | | | | | |
| Comparative | 1:2500 | 1:0.1 | 1 | 99 | 60 | 2.5 |
| Embodiment | | | | | | |
| 3 | | | | | | |
| Comparative | 1:2500 | 1:0.1 | 80 | 20 | 60 | 2.5 |
| Embodiment | | | | | | |
| 4 | | | | | | |
| Comparative | 1:2500 | 1:0.1 | 30 | 70 | 60 | 2.5 |
| Embodiment | | | | | | |
| 5 | | | | | | |
| Comparative | 1:2500 | 1:0.1 | 30 | 70 | 60 | 2.5 |
| Embodiment | | | | | | |
| 6 | | | | | | |

TABLE 2

| | | | | | | | | | | | | Overdis- |
|---|---|---|---|---|---|---|---|---|---|---|---|---|
| | | | | | | | | | | Elong- | 500^{th}- | charge gas- |
| | | | | | | | | | Young's | ation- | cycle | generation |
| | First | Second | A | B | Mw | Viscosity | | | modulus | at-break | expansion | voltage |
| | monomer | monomer | (%) | (%) | (×10⁴) | (mPa · S) | I_{OH} | Qᵥ | (GPa) | (%) | rate (%) | (V) |
| Embodiment 1-1 | Acrylic acid | HEAA | 30 | 70 | 30 | 10685 | 1.34 | 0.85 | 5.2 | 50 | 12.2 | 2.45 |
| Embodiment 1-2 | Acrylic acid | HEAA | 5 | 95 | 17 | 8424 | 2 | 0.8 | 1.5 | 84 | 13.1 | 2.58 |
| Embodiment 1-3 | Acrylic acid | HEAA | 10 | 90 | 25 | 9535 | 1.78 | 0.82 | 2.3 | 76 | 12.8 | 2.51 |
| Embodiment 1-4 | Acrylic acid | HEAA | 40 | 60 | 28 | 10152 | 1.32 | 0.89 | 5.6 | 44 | 14.2 | 2.42 |
| Embodiment 1-5 | Acrylic acid | HEAA | 60 | 40 | 20 | 6842 | 1.13 | 0.9 | 7 | 15 | 14.5 | 2.41 |
| Embodiment 1-6 | Acrylic acid | HEAA | 30 | 70 | 27 | 8421 | 1.35 | 0.82 | 4.8 | 55 | 12.3 | 2.47 |
| Embodiment 1-7 | Acrylic acid | HEAA | 30 | 70 | 35 | 13521 | 1.30 | 0.87 | 5.8 | 37 | 12.5 | 2.43 |
| Embodiment 1-8 | Acrylic acid | HEAA | 30 | 70 | 25 | 9041 | 1.45 | 0.87 | 4.5 | 56 | 12.4 | 2.48 |
| Embodiment 1-9 | Acrylic acid | HEAA | 30 | 70 | 18 | 8414 | 1.52 | 0.89 | 2.8 | 60 | 12.6 | 2.52 |
| Embodiment 1-10 | Acrylic acid | HEAA | 30 | 70 | 21 | 8512 | 1.37 | 0.82 | 4.5 | 54 | 12.5 | 2.48 |
| Embodiment 1-11 | Acrylic acid | HEAA | 30 | 70 | 60 | 21524 | 1.21 | 0.88 | 6.5 | 28 | 13.5 | 2.39 |
| Embodiment 1-12 | Acrylic acid | HEAA | 30 | 70 | 27 | 9624 | 1.21 | 0.83 | 4.1 | 58 | 13.5 | 2.51 |
| Embodiment 1-13 | Acrylic acid | HEAA | 30 | 70 | 58 | 29542 | 1.28 | 0.88 | 5.7 | 40 | 12.5 | 2.43 |
| Embodiment 1-14 | Acrylic acid | HEAA | 30 | 70 | 75 | 41254 | 1.15 | 0.9 | 6.9 | 17 | 12.8 | 2.40 |
| Embodiment 1-15 | Acrylamide | HEAA | 30 | 70 | 32 | 11458 | 1.24 | 0.85 | 4.7 | 53 | 13.6 | 2.48 |
| Embodiment 1-16 | Acrylonitrile | HEAA | 30 | 70 | 35 | 15100 | 1.25 | 0.82 | 6.3 | 33 | 12.5 | 2.58 |
| Embodiment 1-17 | Acrylic acid | β- | 30 | 70 | 33 | 17510 | 1.32 | 0.82 | 5.5 | 46 | 12.3 | 2.57 |
| | | hydroxypropyl | | | | | | | | | | |
| | | acrylate | | | | | | | | | | |
| Embodiment 1-18 | Acrylic acid | Hydroxyethyl | 30 | 70 | 28 | 8425 | 1.49 | 0.81 | 3.8 | 61 | 11.9 | 2.61 |
| | | acrylate | | | | | | | | | | |
| Embodiment 1-19 | Acrylic acid | Hydroxyethyl | 30 | 70 | 26 | 5874 | 1.45 | 0.84 | 4.1 | 55 | 13.5 | 2.55 |
| | | methacrylate | | | | | | | | | | |
| Embodiment 1-20 | Acrylic acid | 4-penten-1-ol | 60 | 40 | 27 | 6425 | 1.76 | 0.8 | 2.5 | 50 | 12.1 | 2.67 |
| Embodiment 1-21 | Acrylonitrile | 4-hydroxybutyl | 30 | 70 | 31 | 15214 | 1.10 | 0.88 | 4.8 | 25 | 14.9 | 2.38 |
| | | acrylate | | | | | | | | | | |
| Embodiment 1-22 | Acrylonitrile | Pentaerythritol | 30 | 70 | 35 | 22415 | 1.58 | 0.8 | 3.5 | 58 | 12.0 | 2.69 |
| | | allyl ether | | | | | | | | | | |
| Embodiment 1-23 | Acrylic acid | HEAA | 20 | 80 | 12 | 3000 | 1.25 | 0.83 | 1.2 | 85 | 13.5 | 2.51 |
| Embodiment 1-24 | Acrylic acid | HEAA | 60 | 40 | 75 | 100000 | 1.15 | 0.9 | 7 | 12 | 13.8 | 2.35 |
| Embodiment 1-25 | Acrylic acid | HEAA | 20 | 80 | 10 | 3512 | 1.72 | 0.81 | 6.8 | 14 | 12.1 | 2.66 |
| Embodiment 1-26 | Acrylic acid | HEAA | 10 | 90 | 15 | 3215 | 1.82 | 0.8 | 0.5 | 88 | 13.8 | 2.58 |
| Embodiment 1-27 | Acrylic acid | HEAA | 60 | 40 | 32 | 52450 | 1.18 | 0.9 | 7.4 | 8 | 14.6 | 2.41 |
| Comparative | / | / | / | / | 35 | 31252 | 1.01 | 0.95 | 7.5 | 2.5 | 15.4 | 2.35 |
| Embodiment 1 | | | | | | | | | | | | |
| Comparative | / | / | / | / | 18 | 2750 | 1.07 | 0.75 | 2.0 | 80 | 12.1 | 2.82 |
| Embodiment 2 | | | | | | | | | | | | |
| Comparative | Acrylic acid | HEAA | 1 | 99 | 14 | 2547 | 2.58 | 0.74 | 0.4 | 115 | 13.8 | 2.80 |
| Embodiment 3 | | | | | | | | | | | | |
| Comparative | Acrylic acid | HEAA | 80 | 20 | 19 | 6000 | 1.1 | 0.93 | 7.8 | 3.2 | 15.1 | 2.39 |
| Embodiment 4 | | | | | | | | | | | | |
| Comparative | Acrylic acid | 2- | 30 | 70 | 29 | 12685 | 1.29 | 0.75 | 2.2 | 76 | 13.2 | 2.78 |
| Embodiment 5 | | (hydroxymethyl) | | | | | | | | | | |
| | | methacrylate | | | | | | | | | | |
| Comparative | Acrylic acid | 5-hydroxypentyl | 30 | 70 | 35 | 24585 | 1.05 | 0.94 | 7.2 | 2.6 | 15.3 | 2.34 |
| Embodiment 6 | | acrylate | | | | | | | | | | |

Note:
“/” in Table 2 means absence of the relevant parameter or substance.

Referring to Table 1 and Table 2, as can be seen from Embodiments 1-1 to 1-27 and Comparative Embodiments 1 to 6, the hydroxyl-modified binder is a copolymer, and the monomers forming the copolymer include the first monomer and the second monomer falling within the ranges specified herein. By controlling the mass percent A % of the first monomer unit and the mass percent B % of the second monomer unit to fall within the ranges specified herein, this application can obtain a hydroxyl-modified binder with Mw, viscosity, I_{OH}, and Qᵥ falling within the ranges specified herein. The film of the hydroxyl-modified binder exhibits appropriate Young's modulus and elongation-at-break. Lithium-ion batteries containing the hydroxyl-modified binder of this application exhibit relatively low expansion rates and overdischarge gas-generation voltages, indicating that the lithium-ion batteries achieve superior cycling expansion performance and low-voltage storage safety performance concurrently. The binder in Comparative Embodiment 1 is PAA, and the binder in Comparative Embodiment 2 is a combination of 8000 PVA and 200% PAA. The mass percent of A % the first monomer unit and the mass percent B % of the second monomer unit in Comparative Embodiments 3 and 4 fall outside the ranges specified herein. The type of the second monomer in Comparative Embodiments 5 and 6 falls outside the range specified herein. At least one of the viscosity, I_{OH}, or Qᵥ of the binder or the Young's modulus or elongation-at-break of the film of the binder in the above comparative embodiments falls outside the ranges specified herein. Consequently, the lithium-ion batteries exhibit a relatively high expansion rate or a relatively high overdischarge gas-generation voltage, indicating that the cycling expansion performance and low-voltage storage safety performance of the lithium-ion batteries are not achieved concurrently.

The values of A and B typically affect the cycling expansion performance and low-voltage storage safety performance of lithium-ion batteries. As can be seen from Embodiments 1-1 to 1-5 and Comparative Embodiments 3 and 4, when the value of A is excessively small and the value of B is excessively large as in Comparative Embodiment 3, the lithium-ion batteries exhibit a relatively low expansion rate and an excessively high overdischarge gas-generation voltage. When the value of A is excessively large and the value of B is excessively small as in Comparative Embodiment 4, the lithium-ion batteries exhibit an excessively high expansion rate and a relatively low overdischarge gas-generation voltage, indicating that the cycling expansion performance and low-voltage storage safety performance of the lithium-ion batteries are not achieved concurrently. Therefore, controlling the values of A and B to fall within the ranges specified herein can enable the lithium-ion batteries to exhibit superior cycling expansion performance and low-voltage storage safety performance concurrently.

The preparation parameters of the hydroxyl-modified binder typically affect the cycling expansion performance and low-voltage storage safety performance of lithium-ion batteries. As can be seen from Embodiments 1-1 and 1-6 to 1-14, adjusting the mass ratio of the second monomer to the solvent, the mass ratio of the second monomer to the free-radical initiator, the mass percent of the first monomer, the mass percent of the second monomer, and the temperature and time of the copolymerization reaction to fall within the ranges specified herein can cause the Mw, viscosity, I_{OH}, and Qᵥ of the hydroxyl-modified binder to fall within the ranges specified herein. Further, and make the film of the hydroxyl-modified binder exhibit appropriate Young's modulus and elongation-at-break. Therefore, the lithium-ion batteries exhibit relatively low expansion rates and overdischarge gas-generation voltages, indicating that the lithium-ion batteries achieve superior cycling expansion performance and low-voltage storage safety performance.

The types of the first monomer and the second monomer typically affect the cycling expansion performance and low-voltage storage safety performance of lithium-ion batteries. As can be seen from Embodiments 1-15 to 1-22, the first monomer and the second monomer falling within the ranges specified herein can cause the film of the hydroxyl-modified binder to exhibit appropriate Young's modulus and elongation-at-break. Therefore, the lithium-ion batteries exhibit relatively low expansion rates and overdischarge gas-generation voltages, indicating that the lithium-ion batteries achieve superior cycling expansion performance and low-voltage storage safety performance.

The values of Mw, viscosity, I_{OH}, and Qᵥ as well as the Young's modulus and elongation-at-break of the hydroxyl-modified binder typically affect the cycling expansion performance and low-voltage storage safety performance of lithium-ion batteries. As can be seen from Embodiments 1-1 to 1-27, with the above parameters controlled to fall within the ranges specified herein, the lithium-ion batteries exhibit relatively low expansion rates and overdischarge gas-generation voltages, indicating that the lithium-ion batteries achieve superior cycling expansion performance and low-voltage storage safety performance.

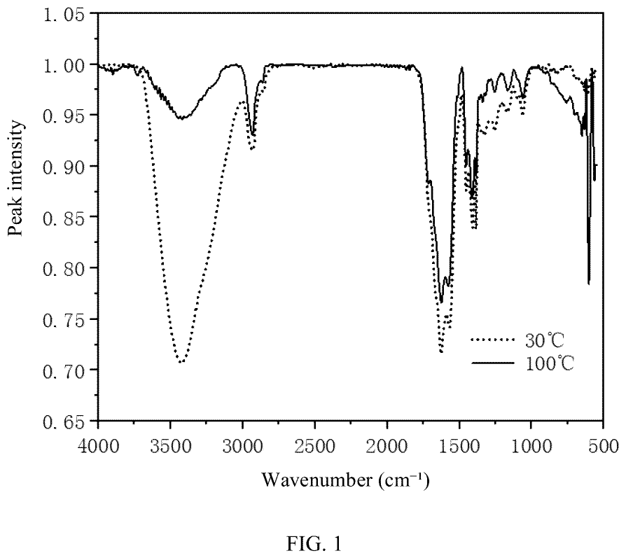

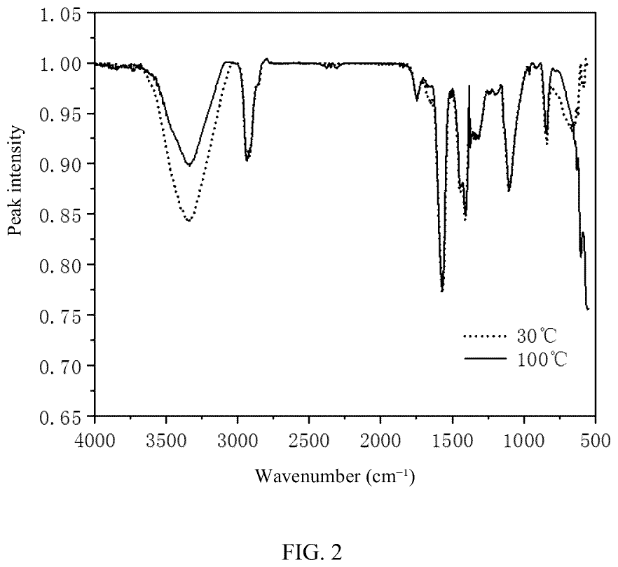

FIG. 1 shows infrared spectra of a hydroxyl-modified binder according to Embodiment 1-1. As shown in FIG. 1, the infrared spectra of the hydroxyl-modified binder of Embodiment 1-1 exhibit a stretching vibration peak of hydroxyl groups at 3000 cm⁻¹ to 3600 cm⁻¹, the peak intensity of the stretching vibration peak at 100° C. is I₁=0.947, and the peak intensity of the stretching vibration peak at 30° C. is I₂=0.700, satisfying: I_{OH}=I₁/I₂=1.34, indicating that the hydroxyl-modified binder of this application is well capable of self-healing. FIG. 2 shows infrared spectra of a polyvinyl alcohol binder according to Comparative Embodiment 2. As shown in FIG. 2, the infrared spectra of the binder of Comparative Embodiment 2 exhibit a stretching vibration peak of hydroxyl groups at 3000 cm⁻¹ to 3600 cm⁻¹, the peak intensity of the stretching vibration peak at 100° C. is I₁=0.900, and the peak intensity of the stretching vibration peak at 30° C. is I₂=0.844, satisfying: I_{OH}=I₁/I₂=1.07, indicating that the polyvinyl alcohol binder is also capable of self-healing. As shown in FIG. 1 in comparison with FIG. 2, the I_{OH} value in Embodiment 1-1 is greater than that of Comparative Embodiment 2, indicating that the hydroxyl-modified binder of Embodiment 1-1 of this application possesses superior self-healing properties.

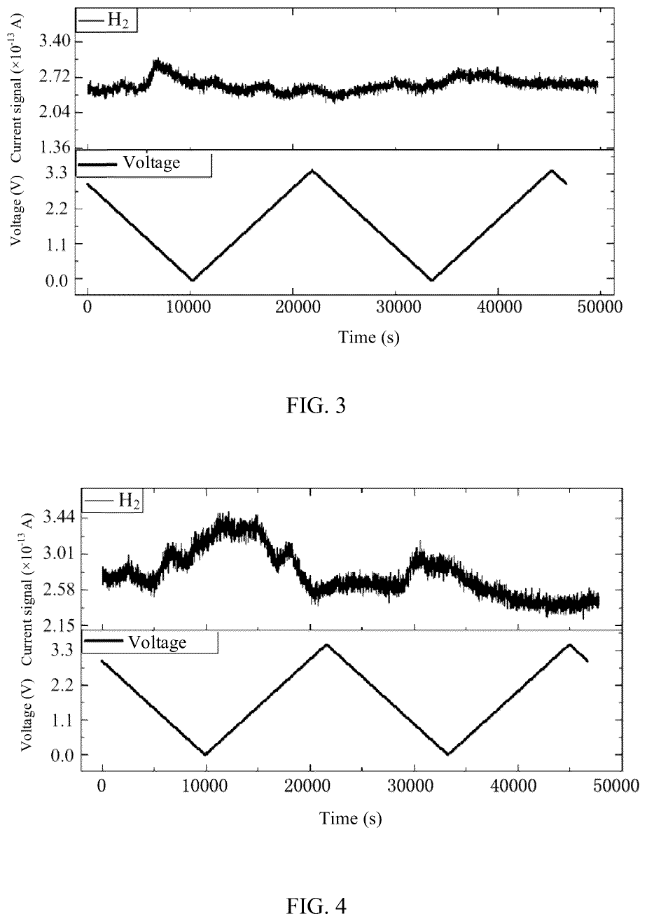

FIG. 3 shows a differential electrochemical mass spectrometry spectrum of a coin cell prepared from a hydroxyl-modified binder and tested by means of cyclic voltammetry according to Embodiment 1-2. FIG. 4 shows a differential electrochemical mass spectrometry spectrum of a coin cell prepared from a binder and tested by means of cyclic voltammetry according to Comparative Embodiment 2. In FIG. 3, during charge-discharge cycles within a voltage window of 0 V to 3.3 V, the weakest current signal value of the hydrogen generated by the hydroxyl-modified binder of Embodiment 1-2 is Q₁=2.38×10⁻¹³ A, the strongest current signal value is Q₂=2.98×10⁻¹³ A, and Qᵥ=Q₁/Q₂=0.8. In FIG. 4, during charge-discharge cycles within a voltage window of 0 V to 3.3 V, the weakest current signal value of the hydrogen generated by the binder of Comparative Embodiment 2 is Q₁=2.58×10⁻¹³ A, the strongest current signal value is Q₂=3.44×10⁻¹³ A, and Qᵥ=Q₁/Q₂=0.75. As can be seen from FIG. 3 and FIG. 4, the Qᵥ value of Embodiments 1-2 is greater than that of Comparative Embodiment 2, indicating that the hydroxyl-modified binder of Embodiments 1-2 of this application produces less gas during charge-discharge cycles.

TABLE 3

| | | | | 500^{th}-cycle expansion | Overdischarge gas- |
|---|---|---|---|---|---|
| | M (%) | N (%) | N/M | rate (%) | generation voltage (V) |
| Embodiment 1-1 | 5 | 2 | 0.4 | 12.2 | 2.45 |
| Embodiment 2-1 | 0.5 | 1.2 | 2.4 | 11.5 | 2.27 |
| Embodiment 2-2 | 20 | 8 | 0.4 | 13.5 | 2.46 |
| Embodiment 2-3 | 40 | 10 | 0.25 | 12.6 | 2.58 |
| Embodiment 2-4 | 60 | 11.5 | 0.19 | 11.8 | 2.61 |
| Embodiment 2-5 | 5 | 1 | 0.2 | 15.8 | 2.35 |
| Embodiment 2-6 | 5 | 1.2 | 0.24 | 13.5 | 2.38 |
| Embodiment 2-7 | 5 | 5 | 1 | 12.3 | 2.50 |
| Embodiment 2-8 | 5 | 8 | 1.6 | 12.4 | 2.52 |
| Embodiment 2-9 | 5 | 11.5 | 2.3 | 13.6 | 2.61 |
| Embodiment 2-10 | 5 | 12 | 2.4 | 14.3 | 2.65 |
| Embodiment 2-11 | 16.5 | 2 | 0.12 | 12.5 | 2.47 |
| Embodiment 2-12 | 5 | 1.25 | 0.25 | 13 | 2.38 |
| Embodiment 2-13 | 0.625 | 2 | 3.2 | 10.8 | 2.37 |
| Embodiment 2-14 | 10 | 4 | 0.40 | 14.3 | 2.43 |
| Embodiment 2-15 | 10 | 8 | 0.8 | 13.5 | 2.51 |

The mass percent M % of silicon typically affects the cycling expansion performance and low-voltage storage safety performance of lithium-ion batteries. As can be seen from Embodiment 1-1 and Embodiments 2-1 to 2-4, with the value of M controlled to fall within the range specified herein, the lithium-ion batteries exhibit relatively low expansion rates and overdischarge gas-generation voltages, indicating that the lithium-ion batteries achieve superior cycling expansion performance and low-voltage storage safety performance.

The mass percent N % of the hydroxyl-modified binder typically affects the cycling expansion performance and low-voltage storage safety performance of lithium-ion batteries. As can be seen from Embodiment 1-1 and Embodiments 2-5 to 2-10, with the value of N controlled to fall within the range specified herein, the lithium-ion batteries exhibit relatively low expansion rates and overdischarge gas-generation voltages, indicating that the lithium-ion batteries achieve superior cycling expansion performance and low-voltage storage safety performance.

The value of N/M typically affects the cycling expansion performance and low-voltage storage safety performance of lithium-ion batteries. As can be seen from Embodiment 1-1 and Embodiments 2-1 to 2-15, with the value of N/M controlled to fall within the range specified herein, the lithium-ion batteries exhibit relatively low expansion rates and overdischarge gas-generation voltages, indicating that the lithium-ion batteries achieve superior cycling expansion performance and low-voltage storage safety performance.

It is hereby noted that, as used herein, the terms “include”, “comprise”, and any variation thereof are intended to cover a non-exclusive inclusion relationship by which a process, method, or object that includes or comprises a series of elements not only includes such elements, but also includes other elements not expressly specified or also includes inherent elements of the process, method, or object.

The terms such as “one of”, “one selected from”, “one thereof” and other similar terms preceding a list of items are intended to mean any one of the listed items. For example, “one of A or B” means A alone or B alone. As another example, “one of A, B, or C” means A alone, B alone, or C alone. The terms such as “at least one of”, “at least one selected from”, “at least one thereof” and other similar terms preceding a list of items are intended to mean any combination of the listed items. For example, “at least one of A or B” means A alone, B alone, or both A and B. As another example, “at least one of A, B, or C” means A alone, B alone, C alone, just A and B, just A and C, just B and C, or all of A, B, and C.

Different embodiments of this application are described in a correlative manner. For the same or similar part in one embodiment, reference may be made to another embodiment. Each embodiment focuses on differences from other embodiments.

The embodiments described above are merely preferred embodiments of this application, but are not intended to limit this application. Any and all modifications, equivalent replacements, improvements, and the like made without departing from the concept and principles of this application still fall within the protection scope of this application.

What is claimed is:

1. A hydroxyl-modified binder, wherein the hydroxyl-modified binder is a copolymer, and monomers forming the copolymer comprise a first monomer and a second monomer; the first monomer comprises at least one of acrylic acid, acrylamide, or acrylonitrile; and the second monomer comprises a compound of Formula I: 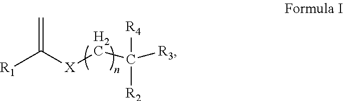
wherein X is selected from C, an ester bond, an ether bond, a methyleneoxy group, or an amide bond; R₁ is selected from H or methyl; R₂, R₃, and R₄ each are independently selected from H, methyl, hydroxyl, or hydroxymethyl; at least one of R₂, R₃, or R₄ is selected from hydroxyl or hydroxymethyl; and n is 0, 1, or 2; and
the first monomer and the second monomer constitute a first monomer unit and a second monomer unit of the copolymer respectively; based on a mass of the copolymer, a mass percentage of the first monomer unit is A %, and a mass percentage of the second monomer unit is B %, wherein 5≤A≤60 and 40≤B≤95.

2. The hydroxyl-modified binder according to claim 1, wherein the second monomer comprises at least one of β-hydroxypropyl acrylate, hydroxypropyl methacrylate, hydroxyethyl acrylate, hydroxyethyl methacrylate, 3-hydroxypropyl acrylate, 4-hydroxybutyl acrylate, 4-penten-1-ol, pentaerythritol allyl ether, or N-(2-hydroxyethyl)acrylamide.

3. The hydroxyl-modified binder according to claim 1, wherein 5≤A≤40, and 60≤B≤95.

4. The hydroxyl-modified binder according to claim 1, wherein, a viscosity of an aqueous dispersion of the hydroxyl-modified binder ranges from 3000 mPa·s to 100000 mPa·s; the viscosity being measured by dispersing the hydroxyl-modified binder in water at a temperature of 25° C. and stirring at a speed of 12 rpm for 2 minutes to form the aqueous dispersion, wherein a mass percentage of the hydroxyl-modified binder in the aqueous dispersion is in a range of 5.5% to 6.5%.

5. The hydroxyl-modified binder according to claim 1, wherein an infrared spectrum of the hydroxyl-modified binder exhibits a stretching vibration peak of hydroxyl groups at 3000 cm⁻¹ to 3600 cm⁻¹, a peak intensity of the stretching vibration peak at 100° C. is I₁, and a peak intensity of the stretching vibration peak at 30° C. is I₂, I_{OH}=I₁/I₂, and I_{OH}≥1.1.

6. The hydroxyl-modified binder according to claim 5, wherein 1.15≤I_{OH}≤2.

7. The hydroxyl-modified binder according to claim 1, wherein, during a charge-discharge cycle of the hydroxyl-modified binder cycled at a voltage of 0 V to 3.3 V, a weakest current signal value of hydrogen is Q₁ A, and a strongest current signal value of hydrogen is Q₂ A, Qᵥ=Q₁/Q₂, and 0.8≤Qᵥ≤0.9.

8. The hydroxyl-modified binder according to claim 1, wherein the hydroxyl-modified binder has at least one of the following characteristics:
(1) a Young's modulus of a film of the hydroxyl-modified binder is 1.2 GPa to 7 GPa;
(2) an elongation-at-break of the film of the hydroxyl-modified binder is 12% to 85%; or
(3) a weight-average molecular weight of the hydroxyl-modified binder is 100,000 g/mol to 750,000 g/mol.

9. A method for preparing the hydroxyl-modified binder according to claim 1, the method comprising following steps:
(1) dissolving the second monomer in a solvent and stirring under protection of an inert atmosphere to obtain a deoxygenated solution;
(2) adding a free-radical initiator into the deoxygenated solution, and then adding the first monomer under protection of an inert atmosphere to perform a copolymerization reaction to obtain a mixed solution containing the hydroxyl-modified binder; and
(3) stirring the mixed solution under negative pressure to remove monomers and isolate the hydroxyl-modified binder, wherein
wherein the solvent comprises at least one of deionized water, ethanol, or acetone; a mass ratio of the second monomer to the solvent is 1:(1000 to 5000); a mass ratio of the second monomer to the free-radical initiator is 1:(0.1 to 2); based on a total mass of the first monomer and the second monomer, a mass percentage of the first monomer is 5% to 60%, and a mass percentage of the second monomer is 40% to 95%; and
the copolymerization reaction is performed at a temperature of 50° C. to 80° C. for a duration of 2 h to 8 h, the negative pressure is set to −0.1 MPa to −0.07 MPa, and the removal of the monomers is performed for a duration of 1 h to 5 h.

10. A secondary battery, comprising a negative electrode plate, wherein the negative electrode plate comprises a negative current collector and a negative electrode material layer disposed on at least one surface of the negative current collector, and the negative electrode material layer comprises a negative active material, and the negative active material comprises a silicon-containing material; and
the negative electrode material layer further comprises the hydroxyl-modified binder according to claim 1.

11. The secondary battery according to claim 10, wherein the silicon-containing material comprises at least one of silicon, a silicon-carbon compound, or a silicon-oxygen compound; and
based on a mass of the negative electrode material layer, a mass percentage of silicon in the silicon-containing material is M %, wherein 0.5≤M≤60.

12. The secondary battery according to claim 11, wherein 5≤M≤40.

13. The secondary battery according to claim 10, wherein, based on a mass of the negative electrode material layer, a mass percentage of the hydroxyl-modified binder is N %, and 1.2≤N≤11.5.

14. The secondary battery according to claim 11, wherein, based on the mass of the negative electrode material layer, a mass percentage of the hydroxyl-modified binder is N %, and 0.12≤N/M≤3.2.

15. The secondary battery according to claim 14, wherein 0.24≤N/M≤1.6.

16. The secondary battery according to claim 10, wherein the second monomer comprises at least one of β-hydroxypropyl acrylate, hydroxypropyl methacrylate, hydroxyethyl acrylate, hydroxyethyl methacrylate, 3-hydroxypropyl acrylate, 4-hydroxybutyl acrylate, 4-penten-1-ol, pentaerythritol allyl ether, or N-(2-hydroxyethyl)acrylamide.

17. The secondary battery according to claim 10, wherein 5≤A≤40, and 60≤B≤95.

18. The secondary battery according to claim 10, wherein, a viscosity of an aqueous dispersion of the hydroxyl-modified binder ranges from 3000 mPa·s to 100000 mPa·s; the viscosity being measured by dispersing the hydroxyl-modified binder in water at a temperature of 25° C. and stirring at a speed of 12 rpm for 2 minutes to form the aqueous dispersion, wherein a mass percentage of the hydroxyl-modified binder in the aqueous dispersion is in a range of 5.5% to 6.5%.

19. The secondary battery according to claim 10, wherein an infrared spectrum of the hydroxyl-modified binder exhibits a stretching vibration peak of hydroxyl groups at 3000 cm⁻¹ to 3600 cm⁻¹, a peak intensity of the stretching vibration peak at 100° C. is I₁, and a peak intensity of the stretching vibration peak at 30° C. is I₂, I_{OH}=I₁/I₂, and I_{OH}≥1.1.

20. The secondary battery according to claim 19, wherein 1.15≤I_{OH}≤2.
